(19) United States
(12) Patent Application Publication
(10) Pub. No.: US 2012/0306860 A1
(43) Pub. Date: Dec. 6, 2012

(54) IMAGE GENERATION SYSTEM, IMAGE GENERATION METHOD, AND INFORMATION STORAGE MEDIUM

(75) Inventors: Koji Hatta, Osaka (JP); Satoshi Kawamoto, Kyoto-shi (JP); Taichi Wada, Ninomiya-machi (JP); Motonaga Ishii, Tokyo (JP)

(73) Assignee: NAMCO BANDAI Games Inc., Tokyo (JP)

(21) Appl. No.: 13/432,246

(22) Filed: Mar. 28, 2012

(30) Foreign Application Priority Data
Jun. 6, 2011 (JP) 2011-126696

(51) Int. Cl. G06T 15/00

(52) U.S. Cl. 345/419

(57) ABSTRACT

An image generation section of the image generation system generates a stereoscopic image so that an information display object is stereoscopically displayed at a first depth position when a parallax level has been set to a first parallax level, and is stereoscopically displayed at a second depth position when the parallax level has been set to a second parallax level. The image generation section generates the stereoscopic image so that a first edge of the information display object is stereoscopically displayed within a first area when the parallax level has been set to the second parallax level, a first boundary plane being a boundary plane specified by a line segment that connects the first edge and a third viewpoint when the parallax level has been set to the first parallax level, and the first area being an area positioned between the first boundary plane and a first clipping plane.

Japanese Patent Application No. 2011-126696 filed on Jun. 6, 2011, is hereby incorporated by reference in its entirety.

### BACKGROUND

The present invention relates to an image generation system, an image generation method, an information storage medium, and the like.

In the fields of movies, games, and the like, a stereoscopic image generation/display system has attracted attention as a system that generates/displays a more realistic image. For example, a binocular stereoscopic image generation/display system generates/displays a left-eye image and a right-eye image. The player who wears stereoscopic glasses observes the left-eye image with the left eye, and observes the right-eye image with the right eye. Stereovision is thus implemented. For example, JP-A-2004-126902 discloses a related-art image generation/display system that implements stereovision.

When generating such a stereoscopic image by means of computer graphics (CG), a left-eye view volume (left-eye view frustum) that corresponds to a left-eye virtual camera is set as the field of view, and a drawing process is performed to generate a left-eye image. Likewise, a right-eye view volume (right-eye view frustum) that corresponds to a right-eye virtual camera is set as the field of view, and a drawing process is performed to generate a right-eye image.

However, an object present within the left-eye view volume may not be present within the right-eye view volume, or an object present within the right-eye view volume may not be present within the left-eye view volume. Specifically, a frame violation (window violation) may occur.

An information display object that presents the game status, the game result, or the like to the player (observer (viewer)) may be displayed on a game screen or the like. The information display object is normally used to display information on a head-up display (HUD).

If the information display object is displayed at an inappropriate position when displaying a stereoscopic image, display of the main display object (e.g., character) may be hindered by the information display object, for example.

### SUMMARY

According to one aspect of the invention, there is provided an image generation system comprising:

a parallax level setting section that sets a parallax level of stereovision; and

an image generation section that generates a first-viewpoint image viewed from a first viewpoint and a second-viewpoint image viewed from a second viewpoint to generate a stereoscopic image, the first viewpoint and the second viewpoint implementing stereovision,

the image generation section generating the stereoscopic image so that an information display object that presents information to an observer is stereoscopically displayed at a first depth position that is behind or in front of a screen when the parallax level has been set to a first parallax level, and the information display object is stereoscopically displayed at a second depth position that is closer to the screen than the first depth position when the parallax level has been set to a second parallax level that is lower than the first parallax level, and

the image generation section generating the stereoscopic image so that a first edge of the information display object is stereoscopically displayed within a first area when the parallax level has been set to the second parallax level, the first edge being a left edge or a right edge of the information display object, a first boundary plane being a boundary plane specified by a line segment that connects the first edge and a third viewpoint when the parallax level has been set to the first parallax level, the third viewpoint being positioned between the first viewpoint and the second viewpoint, a first clipping plane being either clipping plane of a view volume that corresponds to the first viewpoint or a view volume that corresponds to the second viewpoint, and the first area being an area positioned between the first boundary plane and the first clipping plane.

According to another aspect of the invention, there is provided an image generation system comprising:

an information acquisition section that acquires positional relationship information about a screen of a display section and an observer;

a viewpoint selection section that selects a first viewpoint and a second viewpoint that implement multi-view stereovision or spatial imaging stereovision based on the acquired positional relationship information; and

an image generation section that generates a first-viewpoint image viewed from the first viewpoint and a second-viewpoint image viewed from the second viewpoint to generate a stereoscopic image,

the image generation section generating the stereoscopic image so that an information display object that presents information to the observer is stereoscopically displayed within a common area of a view volume that corresponds to the first viewpoint selected based on the positional relationship information and a view volume that corresponds to the second viewpoint selected based on the positional relationship information.

According to another aspect of the invention, there is provided an image generation method that sets a parallax level of stereovision, and generates a first-viewpoint image viewed from a first viewpoint and a second-viewpoint image viewed from a second viewpoint to generate a stereoscopic image, the first viewpoint and the second viewpoint implementing stereovision, the image generation method comprising:

generating the stereoscopic image so that an information display object that presents information to an observer is stereoscopically displayed at a first depth position that is behind or in front of a screen when the parallax level has been set to a first parallax level, and the information display object is stereoscopically displayed at a second depth position that is closer to the screen than the first depth position when the parallax level has been set to a second parallax level that is lower than the first parallax level; and

generating the stereoscopic image so that a first edge of the information display object is stereoscopically displayed within a first area when the parallax level has been set to the second parallax level, the first edge being a left edge or a right edge of the information display object, a first boundary plane being a boundary plane specified by a line segment that connects the first edge and a third viewpoint when the parallax level has been set to the first parallax level, the third viewpoint being positioned between the first viewpoint and the second viewpoint, a first clipping plane being either clipping plane of a view volume that corresponds to the first viewpoint or a view volume that corresponds to the second viewpoint, and the first area being an area positioned between the first boundary plane and the first clipping plane.

According to another aspect of the invention, there is provided an image generation method comprising:

acquiring positional relationship information about a screen of a display section and an observer;

selecting a first viewpoint and a second viewpoint that implement multi-view stereovision or spatial imaging stereovision based on the acquired positional relationship information;

generating a first-viewpoint image viewed from the first viewpoint and a second-viewpoint image viewed from the second viewpoint to generate a stereoscopic image; and

generating the stereoscopic image so that an information display object that presents information to the observer is stereoscopically displayed within a common area of a view volume that corresponds to the first viewpoint selected based on the positional relationship information and a view volume that corresponds to the second viewpoint selected based on the positional relationship information.

According to another aspect of the invention, there is provided a computer-readable information storage medium storing a program that causes a computer to execute the above image generation method.

### BRIEF DESCRIPTION OF THE DRAWINGS

FIG. 1 shows a configuration example of an information generation system according to one embodiment of the invention.

FIG. 2 is a view illustrating a method that sets a left-eye view volume and a right-eye view volume.

FIG. 3 is a view illustrating a method that sets a left-eye view volume and a right-eye view volume.

FIG. 4 is a view illustrating a method according to one embodiment of the invention.

FIG. 5 is a view illustrating a method according to a comparative example.

FIG. 6 is a view illustrating a method according to one embodiment of the invention when an information display object is positioned in front of a screen.

FIG. 7 shows an example of a game image generated using a method according to one embodiment of the invention.

FIG. 8 shows an example of a game image generated using a method according to one embodiment of the invention.

FIG. 9 shows an example of a game image generated using a method according to one embodiment of the invention.

FIGS. 10A and 10B are views illustrating a method that determines the display position of an information display object.

FIG. 11 is a view illustrating a method according to one embodiment of the invention when an information display object is positioned behind a screen.

FIG. 12 is a view illustrating a method that determines the display position of an information display object when the information display object is positioned behind a screen.

FIG. 13 is a view illustrating a method that determines the display position of an information display object when the information display object is positioned behind a screen.

FIG. 14 is a view illustrating a method that determines the display position of an information display object when the information display object is positioned in front of a screen.

FIG. 15 is a view illustrating a method that determines the display position of an information display object when the information display object is positioned in front of a screen.

FIG. 16 is a view illustrating a method that determines the display position of an information display object when the information display object is positioned in front of a screen.

FIG. 17 is a view illustrating a method that changes the display state of an information display object.

FIG. 18 is a view illustrating a viewpoint selection method when implementing multi-view stereovision or the like.

FIG. 19 is a view illustrating a viewpoint selection method when implementing multi-view stereovision or the like.

FIGS. 20A and 20B are views illustrating a method that acquires position information about the left eye and the right eye of the player.

FIG. 21 is a view illustrating a modification of one embodiment of the invention.

FIG. 22 is a view illustrating a modification of one embodiment of the invention.

FIG. 23 is a view illustrating a modification of one embodiment of the invention.

FIG. 24 is a flowchart illustrating a specific process according to one embodiment of the invention.

FIG. 25 is a flowchart illustrating a specific process according to one embodiment of the invention.

### DESCRIPTION OF EXEMPLARY EMBODIMENTS

Several aspects of the invention may provide an image generation system, an image generation method, an information storage medium, and the like that enable appropriate stereoscopic display of an information display object when displaying a stereoscopic image.

According to one embodiment of the invention, there is provided an image generation system comprising:

a parallax level setting section that sets a parallax level of stereovision; and

an image generation section that generates a first-viewpoint image viewed from a first viewpoint and a second-viewpoint image viewed from a second viewpoint to generate a stereoscopic image, the first viewpoint and the second viewpoint implementing stereovision,

the image generation section generating the stereoscopic image so that an information display object that presents information to an observer is stereoscopically displayed at a first depth position that is behind or in front of a screen when the parallax level has been set to a first parallax level, and the information display object is stereoscopically displayed at a second depth position that is closer to the screen than the first depth position when the parallax level has been set to a second parallax level that is lower than the first parallax level, and

the image generation section generating the stereoscopic image so that a first edge of the information display object is stereoscopically displayed within a first area when the parallax level has been set to the second parallax level, the first edge being a left edge or a right edge of the information display object, a first boundary plane being a boundary plane specified by a line segment that connects the first edge and a third viewpoint when the parallax level has been set to the first parallax level, the third viewpoint being positioned between the first viewpoint and the second viewpoint, a first clipping plane being either clipping plane of a view volume that corresponds to the first viewpoint or a view volume that corresponds to the second viewpoint, and the first area being an area positioned between the first boundary plane and the first clipping plane.

According to the image generation system, the information display object is stereoscopically displayed at the first depth position when the parallax level has been set to the first parallax level, and is stereoscopically displayed at the second depth position that is closer to the screen than the first depth position when the parallax level has been set to the second parallax level that is lower than the first parallax level. The first edge of the information display object is stereoscopically displayed within the first area when the parallax level has been set to the second parallax level, the first area being an area positioned between the first clipping plane and the first boundary plane that is specified by a line segment that connects the first edge and the third viewpoint when the parallax level has been set to the first parallax level.

Therefore, since the depth position of the information display object changes corresponding to the parallax level, the information display object can be stereoscopically displayed at a stereoscopic display position optimum for the observer. Moreover, at least the first edge of the information display object is stereoscopically displayed within the first area positioned between the first boundary plane and the first clipping plane even when the parallax level has been set to the second parallax level that is lower than the first parallax level. This makes it possible to display the information display object at a position near the side of the screen, so that the information display object can be appropriately stereoscopically displayed.

In the image generation system,

the image generation section may generate the stereoscopic image so that the information display object is stereoscopically displayed within the first area at a depth position of the screen when the parallax level has been set to zero.

Since the information display object is stereoscopically displayed at the depth position of the screen when the parallax level has been set to zero, an image that appears natural for the observer can be generated.

In the image generation system,

the image generation section may generate the stereoscopic image so that a display position of the information display object when the parallax level has been set to the second parallax level is closer to either side of a screen of a display section as compared with a case where the parallax level has been set to the first parallax level.

According to this feature, since the display position of the information display object can be made close to one side of the screen of the display section, a large display area of the main display object or the like can be provided at the center of the screen, for example.

In the image generation system,

the parallax level setting section may set the parallax level based on operation information from an operation section operated by the observer.

According to this feature, since the depth position of the information display object changes corresponding to a change in parallax level when the parallax level has changed due to the operation of the observer, stereoscopic display that is more appropriate for the observer can be implemented.

In the image generation system,

the image generation section may generate the stereoscopic image by causing a display position of the information display object within the screen to differ between the first-viewpoint image and the second-viewpoint image.

According to this feature, the information display object can be stereoscopically displayed at the stereoscopic display position corresponding to the parallax level by causing the display position of the information display object within the screen to differ between the first-viewpoint image and the second-viewpoint image.

In the image generation system,

the information display object may be a display object that presents game status information, information about a character that appears in a game, game result information, guide information, or character information to the observer.

According to this feature, the game status information, the character information, or the like can be presented to, the observer using the information display object that changes in depth position corresponding to the parallax level.

In the image generation system,

the image generation section may change a display state of the information display object depending on whether the parallax level has been set to the first parallax level or the second parallax level.

This makes it possible for the observer to become visually aware of a change in parallax level due to a change in the display state of the information display object in addition to a change in the depth position of the information display object.

In the image generation system,

the first viewpoint and the second viewpoint may respectively be a viewpoint of a left-eye virtual camera and a viewpoint of a right-eye virtual camera that implement binocular stereovision.

In the image generation system,

the first viewpoint and the second viewpoint may be two viewpoints among a plurality of viewpoints that implement multi-view stereovision, or two arbitrary viewpoints within an observation range that is set to implement spatial imaging stereovision.

When implementing spatial imaging stereovision, a specific viewpoint may not be set during drawing, but a representative observation position is set. Therefore, the positions of the eyes of the observer based on the representative observation position may be used as the first viewpoint and the second viewpoint, for example. Alternatively, positions corresponding to the ends of the observation range may be used as the first viewpoint and the second viewpoint.

The image generation system may further comprise:

an information acquisition section that acquires positional relationship information about a screen of a display section and the observer; and

a viewpoint selection section that selects the first viewpoint and the second viewpoint that implement the multi-view stereovision or the spatial imaging stereovision based on the acquired positional relationship information.

According to another embodiment of the invention, there is provided an image generation system comprising:

an information acquisition section that acquires positional relationship information about a screen of a display section and an observer;

a viewpoint selection section that selects a first viewpoint and a second viewpoint that implement multi-view stereovision or spatial imaging stereovision based on the acquired positional relationship information; and

an image generation section that generates a first-viewpoint image viewed from the first viewpoint and a second-viewpoint image viewed from the second viewpoint to generate a stereoscopic image,

the image generation section generating the stereoscopic image so that an information display object that presents information to the observer is stereoscopically displayed within a common area of a view volume that corresponds to the first viewpoint selected based on the positional relationship information and a view volume that corresponds to the second viewpoint selected based on the positional relationship information.

According to the image generation system, the positional relationship information about the screen of the display section and the observer is acquired, and the first viewpoint and the second viewpoint that implement multi-view stereovision or spatial imaging stereovision are selected based on the acquired positional relationship information. The stereoscopic image is generated so that the information display object is stereoscopically displayed within the common area of the view volume that corresponds to the first viewpoint selected based on the positional relationship information and the view volume that corresponds to the second viewpoint selected based on the positional relationship information. This makes it possible to appropriately stereoscopically display the information display object when implementing multi-view stereovision or spatial imaging stereovision.

In the image generation system,

the information acquisition section may acquire position information about a left eye and a right eye of the observer as the positional relationship information, and

the viewpoint selection section may select the first viewpoint and the second viewpoint based on the position information about the left eye and right eye of the observer.

This makes it possible to select an appropriate first viewpoint and an appropriate second viewpoint corresponding to the position information about the left eye and the right eye of the observer, and stereoscopically display the information display object within the common area of the view volume that corresponds to the first viewpoint and the view volume that corresponds to the second viewpoint.

In the image generation system,

the information acquisition section may acquire the position information about the left eye and the right eye of the observer based on imaging information from an imaging section that images a left-eye marker corresponding to the left eye of the observer and a right-eye marker corresponding to the right eye of the observer.

According to this feature, the position information about the left eye and the right eye of the observer can be easily acquired by merely providing the left-eye marker and the right-eye marker to the recognition member.

Exemplary embodiments of the invention are described below. Note that the following exemplary embodiments do not in any way limit the scope of the invention laid out in the claims. Note also that all of the elements described below should not necessarily be taken as essential elements of the invention.

1. Configuration

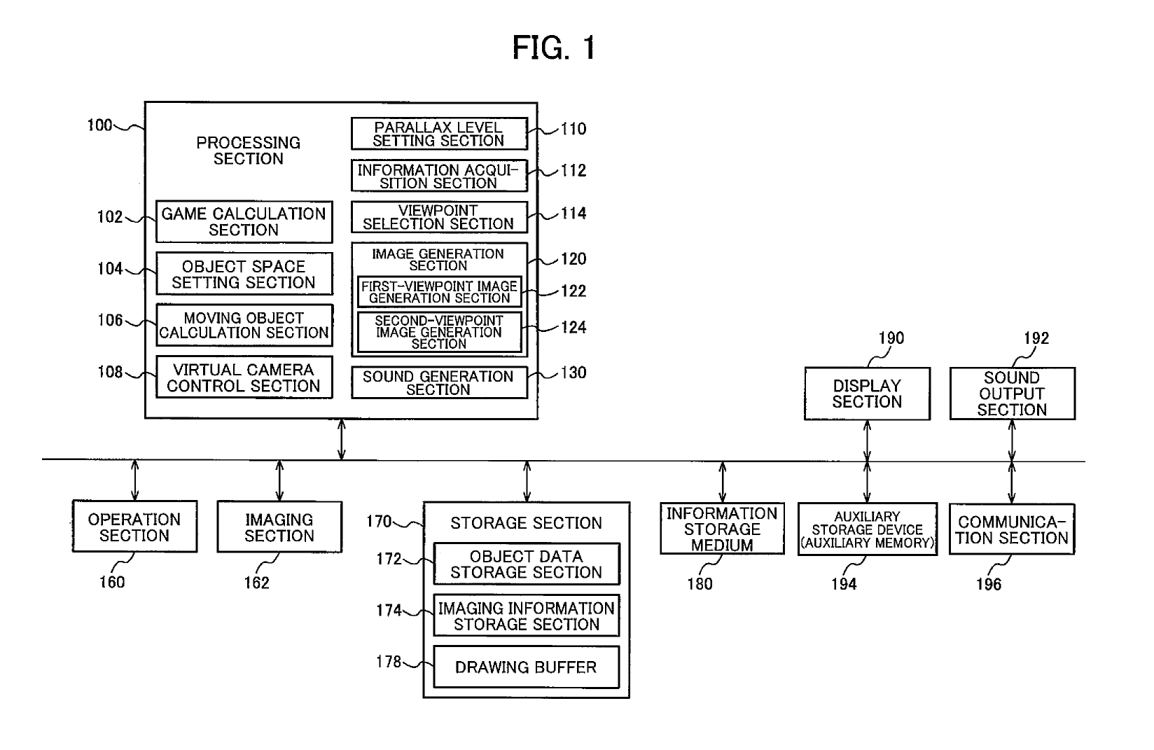

FIG. 1 shows an example of a block diagram of an image generation system (game system) according to one embodiment of the invention. Note that the configuration of the image generation system is not limited to the configuration shown in FIG. 1. Various modifications may be made, such as omitting some of the elements (sections) or adding other elements (sections).

An operation section 160 allows the player to input operation data. The function of the operation section 160 may be implemented by a direction key, an operation button, an analog stick, a lever, a sensor (e.g., angular velocity sensor or acceleration sensor), a microphone, a touch panel display, or the like.

An imaging section 162 captures an object. The imaging section 162 may be implemented by an imaging element (e.g., CCD or CMOS sensor) and an optical system (e.g., lens). Imaging information (captured image data) acquired by the imaging section 162 is stored in an imaging information storage section 174.

A storage section 170 serves as a work area for a processing section 100, a communication section 196, and the like. The function of the storage section 170 may be implemented by a RAM (DRAM or VRAM) or the like. A game program and game data that is necessary when executing the game program are stored in the storage section 170.

An information storage medium 180 (computer-readable medium) stores a program, data, and the like. The function of the information storage medium 180 may be implemented by an optical disk (DVD or CD), a hard disk drive (HDD), a memory (e.g., ROM), or the like. The processing section 100 performs various processes according to one embodiment of the invention based on a program (data) stored in the information storage medium 180. Specifically, a program that causes a computer (i.e., a device including an operation section, a processing section, a storage section, and an output section) to function as each section according to one embodiment of the invention (i.e., a program that causes a computer to execute the process of each section) is stored in the information storage medium 180.

A display section 190 outputs an image generated according to one embodiment of the invention. The function of the display section 190 may be implemented by an LCD, an organic EL display, a CRT, a projector display, a head-mounted display (HMD), or the like. Such a display may be integrated with a touch panel or the like. A sound output section 192 outputs sound generated according to one embodiment of the invention. The function of the sound output section 192 may be implemented by a speaker, a headphone, or the like.

An auxiliary storage device 194 (auxiliary memory or secondary memory) is a storage device used to supplement the capacity of the storage section 170. The auxiliary storage device 194 may be implemented by a memory card such as an SD memory card or a multimedia card, or the like.

The communication section 196 communicates with the outside (e.g., another image generation system, a server, or a host device) via a cable or wireless network. The function of the communication section 196 may be implemented by hardware such as a communication ASIC or a communication processor, or communication firmware.

A program (data) that causes a computer to function as each section according to one embodiment of the invention may be distributed to the information storage medium 180 (or the storage section 170 or the auxiliary storage device 194) from an information storage medium included in a server (host device) via a network and the communication section 196. Use of the information storage medium included in the server (host device) is also included within the scope of the invention.

The processing section 100 (processor) performs a game process, an image generation process, a sound generation process, and the like based on operation data from the operation section 160, a program, and the like. The processing section 100 performs various processes using the storage section 170 as a work area. The function of the processing section 100 may be implemented by hardware such as a processor (e.g., CPU or GPU) or an ASIC (e.g., gate array), or a program.

The processing section 100 includes a game calculation section 102, an object space setting section 104, a moving object calculation section 106, a virtual camera control section 108, a parallax level setting section 110, an information acquisition section 112, a viewpoint selection section 114, an image generation section 120, and a sound generation section 130.

The game calculation section 102 performs a game calculation process. The game calculation process includes starting the game when game start conditions have been satisfied, proceeding with the game, calculating the game results, and finishing the game when game finish conditions have been satisfied, for example.

The object space setting section 104 sets an object space in which a plurality of objects are disposed. For example, the object space setting section 104 disposes an object (i.e., an object formed by a primitive surface such as a polygon, a free-form surface, or a subdivision surface) that represents a display object such as a character (e.g., human, animal, robot, car, ship, or airplane), a map (topography), a building, a course (road), a tree, or a wall in the object space. Specifically, the object space setting section 104 determines the position and the rotation angle (synonymous with orientation or direction) of the object in a world coordinate system, and disposes the object at the determined position (X, Y, Z) and the determined rotation angle (rotation angles around X, Y, and Z-axes). More specifically, an object data storage section 172 included in the storage section 170 stores an object number and object data (e.g., the position, rotation angle, moving speed, and moving direction of the object (part object)) that is linked to the object number. The object space setting section 104 updates the object data every frame, for example.

The moving object calculation section 106 performs calculations for moving a moving object (e.g., character). The moving object calculation section 106 also performs calculations for causing the moving object to make a motion. Specifically, the moving object calculation section 106 causes the moving object (object or model object) to move or make a motion (animation) in the object space based on operation data input by the player using the operation section 160, a program (movement/motion algorithm), data (motion data), and the like. More specifically, the moving object calculation section 106 performs a simulation process that sequentially calculates movement information (position, rotational angle, speed, or acceleration) and motion information (position or rotational angle of a part object) about the moving object every frame (e.g., 1/60th of a second). The term “frame” used herein refers to a time unit used when performing the moving object movement/motion process (simulation process) or the image generation process.

The virtual camera control section 108 controls a virtual camera (viewpoint or reference virtual camera) for generating an image viewed from a given (arbitrary) viewpoint in the object space. Specifically, the virtual camera control section 108 controls the position (X, Y, Z) or the rotation angle (rotation angles around X, Y, and Z-axes) of the virtual camera (i.e., controls the viewpoint position, the line-of-sight direction, or the angle of view).

For example, when photographing a character from behind using the virtual camera, the virtual camera control section 108 controls the position (viewpoint position) and the'direction (line-of-sight direction) of the virtual camera so that the virtual camera follows a change in position or direction of the character. In this case, the virtual camera control section 108 may control the virtual camera based on information (e.g., position, direction, or speed) about the character obtained by the moving object calculation section 106. Alternatively, the virtual camera control section 108 may rotate the virtual camera by a predetermined rotation angle, or may move the virtual camera along a predetermined path. In this case, the virtual camera control section 108 controls the virtual camera based on virtual camera data that specifies the position (moving path) or the direction of the virtual camera. The parallax level setting section 110 sets the parallax level. For example, the parallax level setting section 110 adjusts the parallax level of stereovision.

The information acquisition section 112 acquires various types of information such as positional relationship information about the screen of the display section 190 and the observer (viewer). For example, the information acquisition section 112 acquires position information about the left eye and the right eye of the observer (player in a narrow sense) (positional relationship information about the left eye and the right eye of the observer relative to the screen of the display section) based on the imaging information from the imaging section 162, and the like.

The viewpoint selection section 114 performs a viewpoint selection process when implementing multi-view stereovision or spatial imaging stereovision.

The image generation section 120 performs a drawing process based on the results of various processes (game process and simulation process) performed by the processing section 100 to generate an image, and outputs the generated image to the display section 190. Specifically, the image generation section 120 performs a geometric process (e.g., coordinate transformation (world coordinate transformation and camera coordinate transformation), clipping, perspective transformation, or light source process), and generates drawing data (e.g., primitive surface vertex position coordinates, texture coordinates, color data, normal vector, or α-value) based on the results of the geometric process. The image generation section 120 draws the object (one or more primitive surfaces) subjected to perspective transformation in a drawing buffer 178 (i.e., a buffer (e.g., frame buffer or work buffer) that can store image information corresponding to each pixel) based on the drawing data (primitive surface data). The image generation section 120 thus generates an image viewed from the virtual camera (given viewpoint) in the object space.

The image generation section 120 includes a first-viewpoint image generation section 122 and a second-viewpoint image generation section 124. The first-viewpoint image generation section 122 generates an image viewed from a first viewpoint when implementing stereovision, and the second-viewpoint image generation section 124 generates an image viewed from a second viewpoint when implementing stereovision. For example, when implementing binocular stereovision, the first-viewpoint image generation section 122 generates a left-eye image viewed from a left-eye virtual camera in the object space, and the second-viewpoint image generation section 124 generates a right-eye image viewed from a right-eye virtual camera in the object space.

Note that the image generation section 120 may perform a vertex process, a pixel process, and the like.

Specifically, the image generation section 120 (vertex shader) may perform the vertex process (shading using a vertex shader) based on vertex data (e.g., vertex position coordinates, texture coordinates, color data, normal vector, or α-value) about the object. The image generation section 120 may optionally perform a vertex generation process (tessellation, surface division, or polygon division) for dividing the polygon when performing the vertex process.

In the vertex process, the image generation section 120 performs a vertex moving process and a geometric process such as coordinate transformation (world coordinate transformation or camera coordinate transformation), clipping, or perspective transformation based on a vertex processing program (vertex shader program or first shader program), and changes (updates or adjusts) the vertex data about each vertex that forms the object based on the processing results. The image generation section 120 then performs a rasterization process (scan conversion) based on the vertex data changed by the vertex process so that the surface of the polygon (primitive) is linked to pixels.

The image generation section 120 (pixel shader) may perform the pixel process (shading using a pixel shader or a fragment process) that draws the pixels of the image (fragments that form the display screen) subsequent to the rasterization process.

In the pixel process, the image generation section 120 determines the drawing color of each pixel that forms the image by performing various processes such as a texture reading process (texture mapping), a color data setting/change process, a translucent blending process, and an anti-aliasing process based on a pixel processing program (pixel shader program or second shader program), and outputs (draws) the drawing color of the object that has been subjected to perspective transformation to (in) the drawing buffer 178. Specifically, the pixel process includes a per-pixel process that sets or changes the image information (e.g., color, normal, luminance, and α-value) corresponding to each pixel. The image generation section 120 thus generates an image viewed from the virtual camera (given viewpoint) in the object space.

The vertex process and the pixel process may be implemented by hardware that enables a programmable polygon (primitive) drawing process (i.e., a programmable shader (vertex shader and pixel shader)) based on a shader program written in shading language. The programmable shader enables a programmable per-vertex process and a programmable per-pixel process, and increases the degree of freedom of the drawing process, so that the representation capability can be significantly improved as compared with a fixed drawing process using hardware.

The sound generation section 130 performs a sound process based on the result of various processes performed by the processing section 100 to generate game sound (e.g., background music (BGM), effect sound, or voice), and outputs the generated game sound to the sound output section 192.

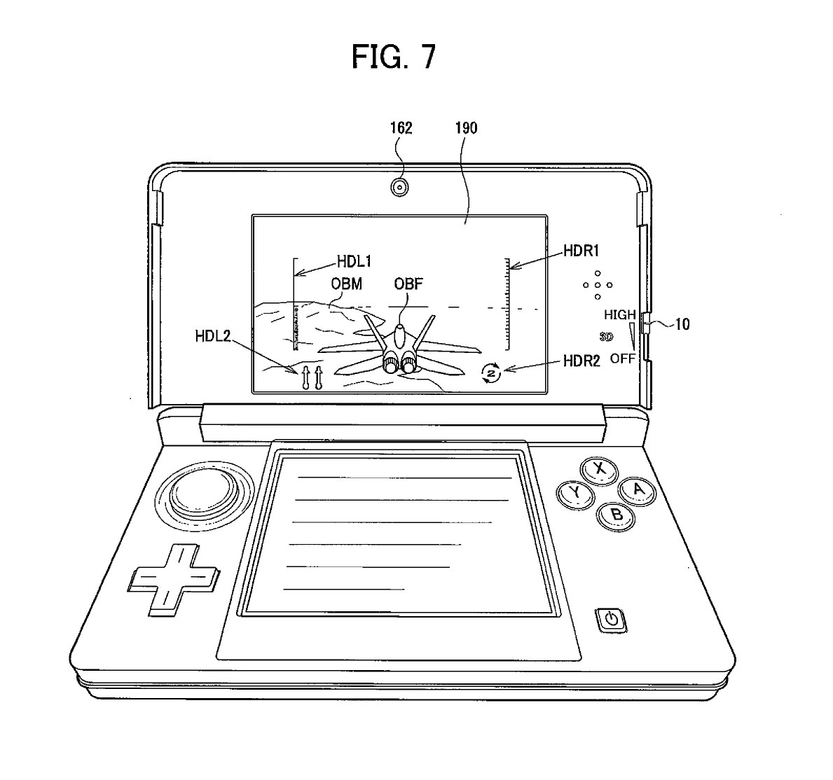

The parallax level setting section 110 sets the parallax level of stereovision. For example, the parallax level setting section 110 sets the parallax level based on operation information from the operation section 160 operated by the observer (player). More specifically, when the observer has moved a slide switch 10 shown in FIG. 7, the parallax level setting section 110 sets the parallax level (3D volume) based on the sliding amount (i.e., operation information). Note that the slide switch 10 need not necessarily be a physical slide switch. For example, a virtual parallax level setting slider or the like that is displayed on the screen may be operated using an input device. The image generation section 120 generates a first-viewpoint image (left-eye image in a narrow sense) viewed from a first viewpoint (left-eye virtual camera in a narrow sense) and a second-viewpoint image (right-eye image in a narrow sense) viewed from a second viewpoint (right-eye virtual camera in a narrow sense) to generate a stereoscopic image. A first-viewpoint image generation section 122 generates the first-viewpoint image, and a second-viewpoint image generation section 124 generates the second-viewpoint image.

The parallax level is information that indicates the stereoscopic level (stereoscopic display level) (i.e., an index that indicates the degree of the stereoscopic effect). The degree of the stereoscopic effect (e.g., the depth of a stereoscopic display object and the extent in the depth direction) can be adjusted by adjusting the parallax level. The parallax level may be set by adjusting a parameter such as the inter-camera distance between a left-eye virtual camera (first-viewpoint camera) and a right-eye virtual camera (second-viewpoint camera). The observer can observe a stereoscopic image with the desired stereoscopic effect by setting the parallax level (stereoscopic level).

For example, when the parallax level has been set to a small value, the inter-camera distance between the left-eye virtual camera and the right-eye virtual camera (inter-viewpoint distance between the first viewpoint and the second viewpoint in a broad sense) is reduced. The stereoscopic effect is reduced (i.e., the display state becomes closer to a two-dimensional display state) by reducing the inter-camera distance. When the parallax level has been set to a large value, the inter-camera distance between the left-eye virtual camera and the right-eye virtual camera is increased. The observer becomes conscious of a higher stereoscopic effect when the inter-camera distance has been increased. Note that the extent to which the inter-camera distance can be increased is limited (e.g., up to a value that corresponds to the eye-to-eye distance of the observer). If the inter-camera distance is increased excessively, the observer may feel tired, or stereovision may not be implemented (i.e., the stereoscopic effect is not necessarily enhanced by increasing the inter-camera distance).

When the parallax level has been set to a first parallax level, the image generation section 120 generates a stereoscopic image so that an information display object that presents information to the observer is stereoscopically displayed at a first depth position in front of or behind a screen (perspective projection screen). When the parallax level has been set to a second parallax level that is lower than the first parallax level, the image generation section 120 generates a stereoscopic image so that the information display object is stereoscopically displayed at a second depth position that is closer to the screen than the first depth position. Specifically, the depth position (i.e., the position in the Z-axis direction) of the information display object in a stereoscopic image (display) is changed corresponding the parallax level. Note that the expression “the information display object is stereoscopically displayed at the first depth position” means that a parallax is applied to the image of the information display object as if the information display object were disposed at the first depth position, and the expression “the information display object is stereoscopically displayed at the second depth position” means that a parallax is applied to the image of the information display object as if the information display object were disposed at the second depth position. Such an effect may be implemented by changing the distance in the horizontal direction (i.e., the distance in the X-axis direction with respect to the screen) between each pixel of the first-viewpoint image (left-eye image) and the corresponding pixel of the second-viewpoint image (right-eye image), for example.

The left edge or the right edge of the information display object with respect to the screen when the parallax level has been set to the first parallax level is referred to as “first edge”, for example. A boundary plane specified by a line segment that connects the first edge and a third viewpoint (center camera in a narrow sense) positioned between the first viewpoint (left-eye virtual camera) and the second viewpoint (right-eye virtual camera) is referred to as “first boundary plane”. Either clipping plane (left or right clipping plane with respect to the screen) of a view volume that corresponds to the first viewpoint or a view volume that corresponds to the second viewpoint is referred to as “first clipping plane”, and an area positioned between the first boundary plane and the first clipping plane is referred to as “first area”. When the horizontal direction with respect to the screen is referred to as “X-axis direction”, the vertical direction with respect to the screen is referred to as “Y-axis direction”, and the depth direction with respect to the screen is referred to as “Z-axis direction”, the first boundary plane is a plane along the Y-axis direction (vertical direction). The terms “left” and “right” respectively refer to the left and the right in the X-axis direction.

In this case, the image generation section 120 generates a stereoscopic image so that the first edge (left edge or right edge) of the information display object is stereoscopically displayed within the first area positioned between the first boundary plane and the first clipping plane when the parallax level has been set to the second parallax level. Specifically, the depth position of the information display object in a stereoscopic image (display) is changed corresponding the parallax level, and a stereoscopic image is generated so that the first edge of the information display object is stereoscopically displayed within the first area positioned between the first clipping plane and the first boundary plane. For example, a stereoscopic image is generated so that the information display object is stereoscopically displayed within a non-frame violation area (non-window violation area) at a position close to the first clipping plane. For example, the information display object is stereoscopically displayed so that the stereoscopic display position of the information display object changes along the first clipping plane corresponding to the parallax level within the non-frame violation area. Therefore, the information display object is displayed at a position near the left edge or the right edge of the screen without entering the frame violation area even if the depth position of the information display object has changed due to a change in parallax level.

When the parallax level has been set to zero, the image generation section 120 generates a stereoscopic image so that the information display object is stereoscopically displayed within the first area at the depth position of the screen. Specifically, the information display object is stereoscopically displayed within the first area at the position of the screen when the parallax level has been set to zero. Note that an image that is displayed when the parallax level has been set to zero is also referred to “stereoscopic image” for convenience.

When the parallax level has been set to the second parallax level, the image generation section 120 generates a stereoscopic image in which the display position of the information display object is close to one side of the screen of the display section 190 as compared with the case where the parallax level has been set to the first parallax level. For example, when a first information display object is displayed on the left side of the screen of the display section 190, and a second information display object is displayed on the right side of the screen of the display section 190, an image is generated so that the first information display object approaches the left edge of the screen, and the second information display object approaches the right edge of the screen when the parallax level has changed from the second parallax level to the first parallax level.

The image generation section 120 may generate a stereoscopic image by causing the display position of the information display object (i.e., the drawing position of a sprite) within the screen to differ between the first-viewpoint image and the second-viewpoint image, for example. For example, when implementing binocular stereovision, the image generation section 120 may generate a stereoscopic image by causing the display position of the information display object (i.e., the position of each corresponding pixel) to differ between the left-eye image and the right-eye image. Note that the information display object may be a three-dimensional information display object having a depth value, and the three-dimensional information display object may be disposed within the object space at a depth position corresponding to the parallax level to generate a stereoscopic image of the information display object.

The information display object is a display object that presents game status information, information about a character that appears in the game, game result information, guide information, character information, or the like to the observer. The game status information includes game progress (process) information, game elapsed time information, game event information, and the like. The information about a character that appears in the game indicates a human character that appears in the game, an item (e.g., airplane or car) possessed by a character, moving information, an attack capability, a defense capability, a current status, and the like. The game result information includes score information about the observer, game point information, victory/defeat information, and the like. The guide information includes information (radar information) that indicates the position of a character or the like on a map, information that indicates the direction in which a character should advance, advice information for the observer, and the like. The character information includes character information about a message displayed to the observer, character information that indicates the current situation, subtitle information, and the like.

The image generation section 120 may change the display state of the information display object depending on whether the parallax level has been set to the first parallax level or the second parallax level. For example, the image generation section 120 may display the information display object in a first display state when the parallax level has been set to the first parallax level, and may display the information display object in a second display state that differs from the first display state when the parallax level has been set to the second parallax level. Examples of the display state include hue, brightness, intensity, translucency, a blur level, a texture to be mapped, a visual effect, and the like.

Note that the first viewpoint and the second viewpoint used to generate the first-viewpoint image and the second-viewpoint image respectively refer to the viewpoint of a left-eye virtual camera and the viewpoint of a right-eye virtual camera that implement binocular stereovision, for example. The first viewpoint and the second viewpoint may be viewpoints that are used to implement multi-view stereovision or spatial imaging stereovision and take account of the position of the observer. For example, the first viewpoint and the second viewpoint may be two viewpoints among a plurality of viewpoints that implement multi-view stereovision, or two arbitrary viewpoints within an observation range that is set to implement spatial imaging stereovision.

The information acquisition section 112 acquires positional relationship information about the screen of the display section 190 and the observer. The positional relationship information is position information about the left eye and the right eye of the observer, for example. Note that it suffices that the positional relationship information be information that indicates the relative positional relationship between the screen of the display section 190 and the observer (i.e., the left eye and the right eye of the observer). For example, motion information about the screen of the display section 190 relative to the observer may be acquired as the positional relationship information. For example, when the player has moved a portable game device, the positional relationship information may be acquired by detecting the motion of the screen or the like using a built-in motion sensor (e.g., gyrosensor or acceleration sensor).

The viewpoint selection section 114 selects the first viewpoint and the second viewpoint that implement multi-view stereovision or spatial imaging stereovision based on the acquired positional relationship information. The image generation section 120 generates the first-viewpoint image viewed from the first viewpoint and the second-viewpoint image viewed from the second viewpoint to generate a stereoscopic image, the first viewpoint and the second viewpoint implementing stereovision. For example, the image generation section 120 generates an image that should be observed by the observer with the left eye as the first-viewpoint image, and generates an image that should be observed by the observer with the right eye as the second-viewpoint image. When implementing spatial imaging stereovision, the image drawing range may be set to include the first viewpoint and the second viewpoint that have been selected, and an image within the image drawing range may be generated.

The image generation section 120 generates a stereoscopic image so that the information display object that presents information to the observer is stereoscopically displayed within a common area (non-frame violation area) of a view volume that corresponds to the first viewpoint selected based on the positional relationship information and a view volume that corresponds to the second viewpoint selected based on the positional relationship information. More specifically, the image generation section 120 generates a stereoscopic image so that the information display object is stereoscopically displayed within the common area at a depth position corresponding to the parallax level that has been set. For example, when the first viewpoint for generating the first-viewpoint image and the second viewpoint for generating the second-viewpoint image have been selected when implementing multi-view stereovision or spatial imaging stereovision, the image generation section 120 generates a stereoscopic image so that the information display object is stereoscopically displayed within the common area of the view volume that corresponds to the first viewpoint and the view volume that corresponds to the second viewpoint. According to this configuration, when the first viewpoint and the second viewpoint have been selected when implementing multi-view stereovision or spatial imaging stereovision, the information display object can be stereoscopically displayed at a display position optimum for the first viewpoint and the second viewpoint.

In this case, the information acquisition section 112 may acquire the position information about the left eye and the right eye of the observer as the positional relationship information. For example, the information acquisition section 112 acquires the position information about the left eye and the right eye relative to the screen of the display section 190 (binocular tracking process).

The viewpoint selection section 114 selects the first viewpoint and the second viewpoint based on the position information about the left eye and the right eye of the observer. More specifically, a left-eye marker corresponding to the left eye of the observer and a right-eye marker corresponding to the right eye of the observer are provided to a recognition member worn by the observer. The information acquisition section 112 acquires the position information about the left eye and the right eye of the observer based on the imaging information from the imaging section 162 that images the recognition member worn by the observer. Specifically, an image of the recognition member worn by the observer is captured using the imaging section 162, and the left-eye marker and the right-eye marker of the recognition member are recognized by an image recognition process based on the imaging information. The position of the left-eye marker and the position of the right-eye marker are detected based on the image recognition results to obtain the position information about the left eye and the right eye of the observer. This makes it possible to detect the position information about the left eye and the right eye of the observer by a simple process that effectively utilizes the imaging section 162. The marker may be attached to glasses of an eyeglass-type stereoscopic display device. The marker need not be used when the position of the left eye and the position of the right eye can be detected by face recognition technology or the like without using the marker.

The virtual camera control section 108 controls a reference viewpoint (reference virtual camera or central camera) that is used as a reference for setting the first viewpoint (left-eye virtual camera) and the second viewpoint (right-eye virtual camera), for example. For example, the reference viewpoint is a viewpoint that is positioned between the first viewpoint and the second viewpoint. The virtual camera control section 108 calculates position information (viewpoint position) and direction information (line-of-sight direction) about the first viewpoint (left-eye virtual camera) and the second viewpoint (right-eye virtual camera) based on position information and direction information about the reference viewpoint and information about the inter-viewpoint distance (inter-camera distance). Note that the virtual camera control section 108 may directly control the first viewpoint (left-eye virtual camera) and the second viewpoint (right-eye virtual camera).

The stereovision may be implemented by a stereoscopic glass method, a naked-eye method using a parallax barrier, a lenticular lens, or another optical element that can control the beam direction, or the like. Examples of the stereoscopic glass method include a polarized glass method, a page-flip method, a color separation method, and the like. When using the polarized glass method, a left-eye image and a right-eye image are alternately displayed in an odd-numbered line and an even-numbered line of the display section 190, and are observed through polarized glasses (e.g., glasses provided with a horizontal polarizing filter (left) and a vertical polarizing filter (right)) to implement stereovision. Alternatively, a left-eye image and a right-eye image may be projected using a projector provided with a special polarizing filter, and observed through polarized glasses to implement stereovision. When using the page-flip method, a left-eye image and a right-eye image are alternately displayed on the display section 190 in a given cycle (e.g., every 1/120th of a second or 1/60th of a second). A left-eye liquid crystal shutter and a right-eye liquid crystal shutter of glasses are alternately opened and closed in the above cycle to implement stereovision. When using the color separation method, an anaglyph image is generated, and observed through red-cyan glasses or the like to implement stereovision, for example.

The image generation section 120 or the display section 190 (e.g., television) may have the function of generating a stereoscopic image using the left-eye image and the right-eye image. For example, the image generation section 120 outputs side-by-side image signals. The display section 190 then displays a field-sequential image in which the left-eye image and the right-eye image are alternately assigned to an odd-numbered line and an even-numbered line based on the side-by-side image signals. The display section 190 may display a frame-sequential image in which the left-eye image and the right-eye image are alternately switched in a given cycle. Alternatively, the image generation section 120 may generate a field-sequential image or a frame-sequential image, and output the generated image to the display section 190.

2. Method

A method according to one embodiment of the invention is described in detail below.

2.1 Stereoscopic Display of Information Display Object Corresponding to Parallax Level

A view volume is set as described below when implementing stereovision. Note that the following description is given mainly taking an example of implementing binocular stereovision. When implementing binocular stereovision, the first viewpoint is the viewpoint of a left-eye virtual camera, and the second viewpoint is the viewpoint of a right-eye virtual camera, for example. Note that the method according to one embodiment of the invention may also be applied to various types of stereovision (e.g., multi-view stereovision or spatial imaging stereovision) (described later) other than binocular stereovision.

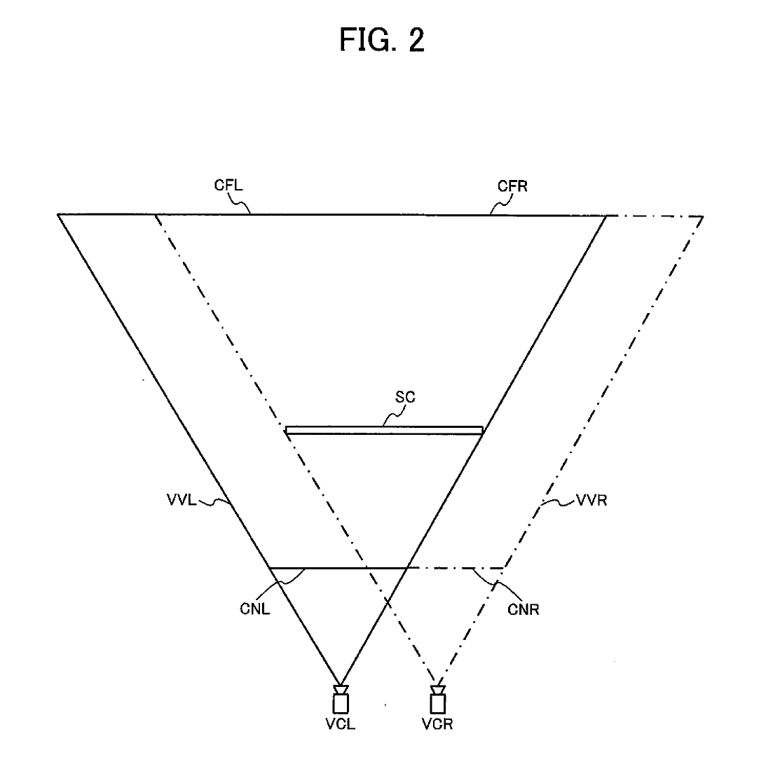

As shown in FIG. 2, a left-eye virtual camera VCL (first-viewpoint camera in a broad sense) and a right-eye virtual camera VCR (second-viewpoint camera in a broad sense) that are set at a given inter-camera distance are used to generate a stereoscopic image.

A left-eye view volume VVL (left-eye view frustum, view volume that corresponds to the first viewpoint, or first-viewpoint view frustum) is set corresponding to the left-eye virtual camera VCL, and a right-eye view volume VVR (right-eye view frustum, view volume that corresponds to the second viewpoint, or second-viewpoint view frustum) is set corresponding to the right-eye virtual camera VCR. Specifically, the position and the direction of the left-eye view volume VVL are set based on the position and the direction of the left-eye virtual camera VCL, and the position and the direction of the right-eye view volume VVR are set based on the position and the direction of the right-eye virtual camera VCR.

A left-eye image (i.e., an image viewed from the left-eye virtual camera VCL) is generated by perspectively projecting (drawing) an object present within the left-eye view volume VVL onto a screen SC. A right-eye image (i.e., an image viewed from the right-eye virtual camera VCR) is generated by perspectively projecting (drawing) an object present within the right-eye view volume VVR onto the screen SC. Since an object that is not perspectively projected onto the screen SC is excluded from the drawing target, it is useless to perform the perspective projection transformation process on such an object.

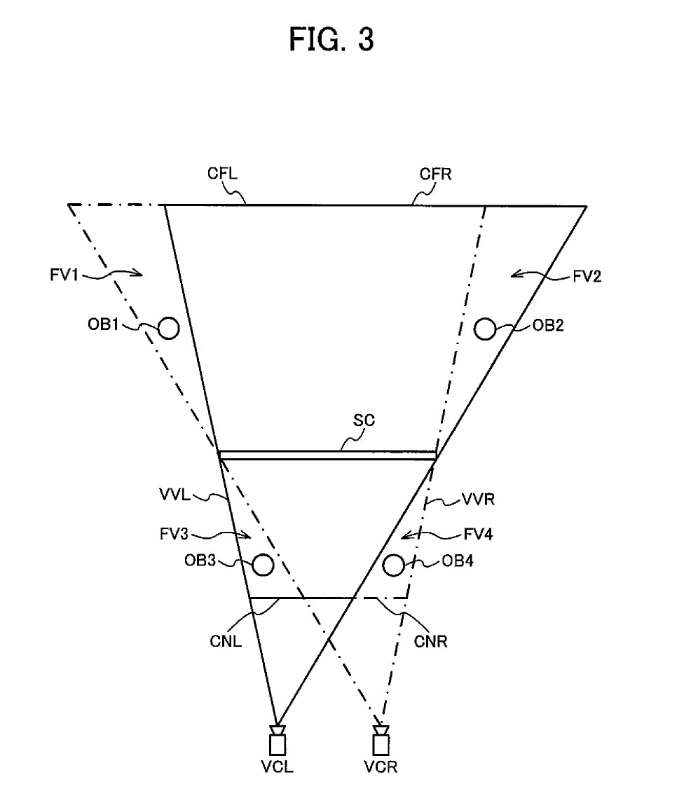

Therefore, the left-eye view volume VVL and the right-eye view volume VVR are actually set as shown in FIG. 3. Specifically, an object that is not perspectively projected onto the screen SC is excluded from the drawing target by a clipping process using the left-eye view volume VVL and the right-eye view volume VVR. This makes it possible to prevent a situation in which an unnecessary process is performed, so that the processing load can be reduced.

In FIG. 3, reference symbols CNL and CFL respectively indicate the near clipping plane and the far clipping plane of the left-eye view volume VVL, and reference symbols CNR and CFR respectively indicate the near clipping plane and the far clipping plane of the right-eye view volume VVR.

When the left-eye view volume VVL and the right-eye view volume VVR are set as shown in FIG. 3, objects OB2 and OB3 are present within the left-eye view volume VVL, but are not present within the right-eye view volume VVR, for example. Therefore, the objects OB2 and OB3 are drawn on the screen SC when generating the left-eye image, but are not drawn on the screen SC when generating the right-eye image. Accordingly, the player (observer in a broad sense) can observe an image of the objects OB2 and OB3 with the left eye that sees the left-eye image, but cannot observe an image of the objects OB2 and OB3 with the right eye that sees the right-eye image.

Likewise, objects OB1 and OB4 are present within the right-eye view volume VVR, but are not present within the left-eye view volume VVL. Therefore, since the objects OB1 and OB4 are drawn when generating the right-eye image, but are not drawn when generating the left-eye image, the player can observe an image of the objects OB1 and OB4 with the right eye, but cannot observe an image of the objects OB1 and OB4 with the left eye.

An area that can be observed with only the left eye or the right eye is referred to as “frame violation area (window violation area)” (see FV1, FV2, FV3, and FV4). The frame violation areas FV1, FV2, FV3, and FV4 belong to only one of the left-eye view volume VVL and the right-eye view volume VVR (i.e., do not belong to both the left-eye view volume VVL and the right-eye view volume VVR).

An area that can be observed with both the left eye and the right eye is referred to as “non-frame violation area (non-window violation area)”. The non-frame violation area is an area (common area) that belongs to both the left-eye view volume VVL and the right-eye view volume VVR.

The objects OB1, OB2, OB3, and OB4 that are respectively present in the frame violation areas FV1, FV2, FV3, and FV4 (see FIG. 3) can be observed with only the left eye or the right eye. If the observable object differs between the left eye and the right eye of the player, the player may be given an odd impression when observing a stereoscopic image. In particular, when an object is present to cross the clipping plane of the view volume, the object is clipped by the clipping plane when observed with one eye, but is not clipped by the clipping plane when observed with the other eye, so that an inconsistent (unnatural) stereoscopic image (stereovision) may be generated.

In one embodiment of the invention, the player can arbitrarily set the parallax level that indicates the stereoscopic level using the slide switch 10 (operation section in a broad sense) (see FIG. 7). For example, the parallax level increases when the player has moved the slide switch 10 (see FIG. 7) upward, so that a highly stereoscopic image is displayed on the display section 190. The parallax level decreases when the player has moved the slide switch 10 downward, so that a weakly stereoscopic image is displayed on the display section 190. The parallax level becomes zero when the player has moved the slide switch 10 to the lowermost position, so that a two-dimensional mage (2D image) is displayed on the display section 190. Note that an image displayed when the parallax level is zero is also referred to “stereoscopic image” for convenience.

As shown in FIG. 7, an information display object (HDL1, HDL2, HDR1, and HDR2) that presents information about the game to the player is displayed within the game screen. The information display object is normally used to display information on a head-up display (HUD), and differs from a main display object (e.g., character or background) displayed within the game screen. The information display object is a figure, a symbol, a character, or the like, and presents game status information, character information, game result information, or the like to the player.

When the player can arbitrarily set the parallax level, it is important to appropriately display the information display object within the game screen. If the display state of the information display object does not change even if the player has changed the parallax level, the effects of the game may be impaired, or the player may be given an odd impression. For example, if the display state of the information display object does not change even if the player has set the parallax level to the maximum value so that the main display object (e.g., character) is highly stereoscopically displayed, or the player has set the parallax level to zero so that the main display object is two-dimensionally displayed, the effects of the game may be impaired, or the player may be given an odd impression.

In order to deal with the above problem, one embodiment of the invention employs a method that changes the depth position of the information display object in a stereoscopic image corresponding to the parallax level. For example, a stereoscopic image is generated so that the information display object is stereoscopically displayed at a depth position away from the screen when the parallax level has been set to a high parallax level, and is stereoscopically displayed at a depth position close to the screen when the parallax level has been set to a low parallax level.

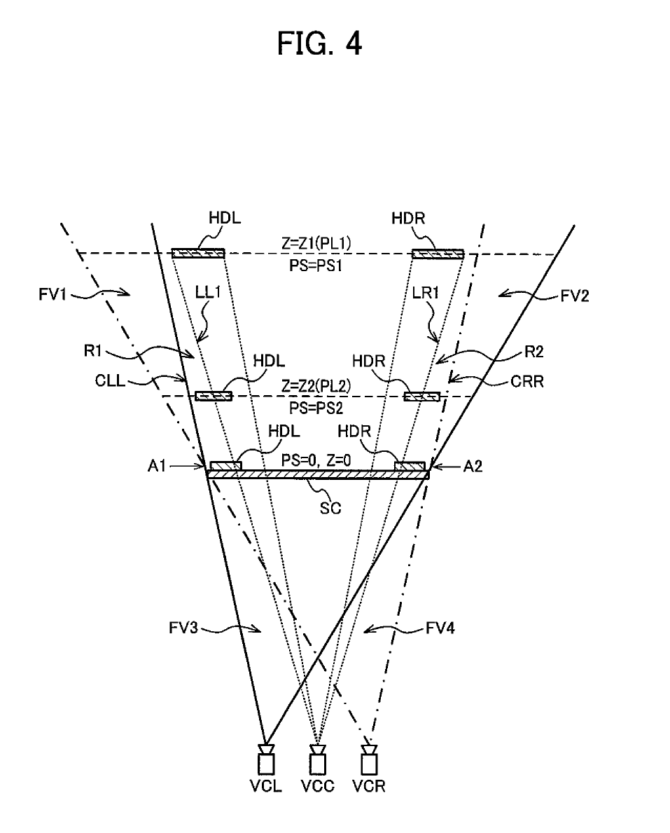

As shown in FIG. 4, when the parallax level PS has been set to a high parallax level PS1 (first parallax level), an image is generated so that the information display objects HDL and HDR are stereoscopically displayed at a depth position Z=Z1 (first depth position (plane PL1 at the depth position Z1)) away from the screen SC.

When the parallax level PS has been set to a low parallax level PS2 (second parallax level) that is lower than the parallax level PS1, an image is generated so that the information display objects HDL and HDR are stereoscopically displayed at a depth position Z=Z2 (second depth position (plane PL2 at the depth position Z2)) close to the screen SC. When the parallax level PS has been set to zero, an image is generated so that the information display objects HDL and HDR are stereoscopically displayed at a depth position Z=0 of the screen SC. When drawing a normal three-dimensional object space, the inter-camera distance (i.e., the distance between the camera VCL and the camera VCR) is normally reduced when the parallax level PS has been reduced. In this case, the view volume of each camera changes, so that the positions of the clipping planes CLL and CRR also change. This necessarily requires a complicated explanation. The description herein is given on the assumption that the depth position of the information display object is brought closer to the screen (see FIG. 4) when the parallax level PS has been reduced instead of reducing the distance between the camera VCL and the camera VCR.

The effects of the game can be improved by thus changing the depth position of the information display object in a stereoscopic image corresponding to the parallax level. More specifically, the depth position of the information display object moves backward when the stereoscopic effect on the main display object (e.g., character) has increased due to an increase in parallax level, and moves forward when the stereoscopic effect on the main display object has decreased due to a decrease in parallax level. Therefore, the stereoscopic effect on the main display object and the depth position of the information display object change in synchronization, so that the effects of the game and the like can be improved. Moreover, since the information presented to the player using the information display object is ordered by changing the depth position of the information display object corresponding to the parallax level, a game image convenient to the player (i.e., easy to observe and understand) can be generated.

However, the display area of the main game screen decreases when the information display object hinders display of the main display object (e.g., character). If the information display object is disposed close to the edge of the screen in order to prevent such a situation, the information display object may enter the frame violation area, and may be hard to observe.

In order to deal with the above problem, one embodiment of the invention employs a method that displays the information display object near the left side or the right side of the screen as much as possible, while preventing a situation in which the information display object enters the frame violation area even if the depth position of the information display object has changed due to a change in parallax level.

A center camera VCC (third viewpoint in a broad sense) (reference virtual camera) shown in FIG. 4 is a camera (viewpoint) disposed between the left-eye virtual camera VCL (first viewpoint in a broad sense) and the right-eye virtual camera VCR (second viewpoint in a broad sense).

A boundary plane LL1 (first boundary plane) is a boundary plane (boundary line) that is specified by a line segment that connects the center camera VCC (third viewpoint) and the left edge (first edge) of the information display object HDL when the parallax level PS is set to PS1 (first parallax level). The boundary plane LL1 is a plane along the vertical direction (Y-axis direction) with respect to the screen SC.

The clipping plane CLL is the left clipping plane (one clipping plane) of the left-eye view volume (view volume that corresponds to the first viewpoint). An area R1 (first area) is an area positioned between the boundary plane LL1 and the clipping plane CLL. Specifically, the area R1 is specified by the boundary plane LL1 and the clipping plane CLL.

Likewise, a boundary plane LR1 (first boundary plane) is a boundary plane (boundary line) that is specified by a line segment that connects the center camera VCC (third viewpoint) and the right edge (first edge) of the information display object HDR when the parallax level PS is set to PS1 (first parallax level). The boundary plane LR1 is a plane along the vertical direction (Y-axis direction) with respect to the screen SC.

The clipping plane CRR is the right clipping plane (one clipping plane) of the right-eye view volume (view volume that corresponds to the second viewpoint). An area R2 (first area) is an area positioned between the boundary plane LR1 and the clipping plane CRR. Specifically, the area R2 is specified by the boundary plane LR1 and the clipping plane CRR.

When the parallax level PS has been set to PS2 (see FIG. 4), an image is generated so that the left edge (first edge) of the information display object HDL is stereoscopically displayed within the area R1 (first area). For example, when the parallax level has changed from PS1 to PS2, and the depth position of the information display object HDL has changed from Z1 to Z2, the information display object HDL is moved along the left clipping plane CLL of the left-eye view volume. When the parallax level PS has been set to zero, the information display object HDL is stereoscopically displayed within the area R1 at the depth position (Z=0) of the screen SC.

When the parallax level PS has been set to PS2, an image is generated so that the right edge (first edge) of the information display object HDR is stereoscopically displayed within the area R2 (first area). For example, when the parallax level has changed from PS1 to PS2, and the depth position of the information display object HDR has changed from Z1 to Z2, the information display object HDR is moved along the right clipping plane CRR of the right-eye view volume. When the parallax level PS has been set to zero, the information display object HDR is stereoscopically displayed within the area R2 at the depth position (Z=0) of the screen SC.

According to the above method, the left information display object HDL is displayed at a position near the left edge of the screen (see A1 in FIG. 4), and the right information display object HDR is displayed at a position near the right edge of the screen (see A2). Therefore, since the information display objects HDL and HDR do not hinder the main display object (e.g., character) displayed at the center of the screen, the information can be presented using the information display objects HDL and HDR in a more ordered manner. Moreover, it is possible to prevent a situation in which the stereoscopic display positions of the information display objects HDL and HDR enter the frame violation areas FV1 and FV2 by setting the stereoscopic display positions of the information display objects HDL and HDR within the areas R1 and R2.

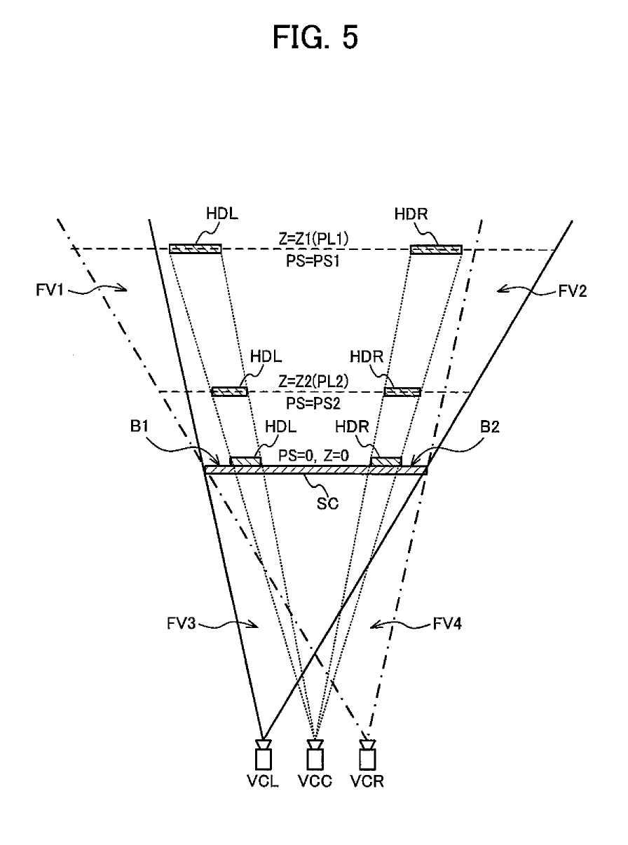

FIG. 5 shows a comparative example of one embodiment of the invention. In the comparative example shown in FIG. 5, when the parallax level has changed from PS1 to PS2, the depth position of the information display objects HDL and HDR changes from Z1 to Z2.

In the comparative example shown in FIG. 5, the stereoscopic display position of the information display object HDL changes along a line segment that connects the center camera VCC and the position of the information display object HDL when the depth position Z is Z1. The stereoscopic display position of the information display object HDR changes along a line segment that connects the center camera VCC and the position of the information display object HDR when the depth position Z is Z1. According to the comparative example, the size of the information display objects HDL and HDR within the screen SC can be made constant even if the depth position of the information display objects HDL and HDR has changed due to a change in parallax level.

According to the comparative example, however, since the information display object HDL is displayed at a position away from the left side of the screen (see B1 in FIG. 5), an unnecessary space is formed near the left side of the screen. Likewise, since the information display object HDR is displayed at a position away from the right side of the screen (see B2), an unnecessary space is formed near the right side of the screen. Since the information display objects HDL and HDR thus hinder the main display object (e.g., character) displayed at the center of the screen, a game screen inconvenient to the player is displayed. The information display objects HDL and HDR hinder the main display object (e.g., character) displayed at the center of the screen to the same extent regardless of whether the parallax level PS is PS1 or PS2. In the comparative example, priority is given to display the information display objects HDL and HDR so as not to enter the frame violation area. However, since the frame violation area becomes narrow as the parallax level decreases, the player gradually becomes aware that the information display objects HDL and HDR are disposed in an unnecessarily narrow area.

According to one embodiment of the invention, since the display positions of the information display objects HDL and HDR can be respectively moved toward the left side and the right side of the screen (see A1 and A2 in FIG. 4) even if the depth position of the information display objects HDL and HDR has changed due to a change in parallax level, an ordered game screen convenient to the player can be displayed.

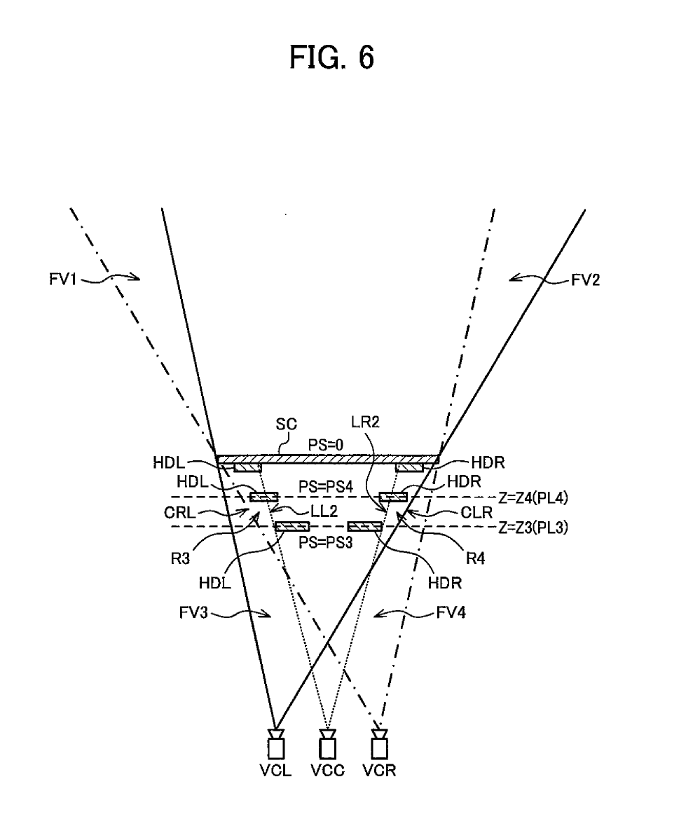

As shown in FIG. 6, the stereoscopic display positions of the information display objects HDL and HDR may be changed corresponding to the parallax level in an area positioned in front of the screen SC, differing from FIG. 4.

In the example shown in FIG. 6, when the parallax level has changed from PS3 (first parallax level) to PS4 (second parallax level), and the depth position of the information display object HDL has changed from Z3 (first depth position) to Z4 (second depth position), the left edge (first edge) of the information display object HDL is stereoscopically displayed in an area R3 (first area) positioned between a clipping plane CRL and a boundary plane LL2. Specifically, the information display object HDL moves along the left clipping plane CRL of the right-eye view volume. Note that the boundary plane LL2 is a boundary plane that is specified by a line segment that connects the center camera VCC and the left edge of the information display object HDL when the parallax level PS is set to PS3.

When the parallax level has changed from PS3 to PS4, and the depth position of the information display object HDR has changed from Z3 to Z4, the right edge (first edge) of the information display object HDR is stereoscopically displayed in an area R4 (first area) positioned between a clipping plane CLR and a boundary plane LR2. Specifically, the information display object HDR moves along the right clipping plane CLR of the left-eye view volume. Note that the boundary plane LR2 is a boundary plane that is specified by a line segment that connects the center camera VCC and the right edge of the information display object HDR when the parallax level PS is set to PS3.

The depth position (stereoscopic display position) of the information display object may be changed by various methods. For example, the depth position (stereoscopic display position) of the information display object may be changed by causing the display position of the information display object within the screen to differ between the left-eye image and the right-eye image.

For example, when the parallax level has been set to PS1, and the depth position has been set to Z1 (i.e., a depth position away from the screen SC), the distance between the display position of the information display object in the left-eye image and the display position of the information display object in the right-eye image is increased. When the parallax level has been set to PS2, and the depth position has been set to Z2 (i.e., a depth position close to the screen SC), the distance between the display position of the information display object in the left-eye image and the display position of the information display object in the right-eye image is reduced as compared with the case where the depth position is set to Z1. In this case, the information display object is drawn at the screen position using a sprite.

Alternatively, the information display object may be a three-dimensional object, and may be disposed at the corresponding depth position within the object space. For example, when the parallax level has been set to PS1, the information display object (three-dimensional object) is disposed within the object space at the depth position Z1 away from the screen SC. When the parallax level has been set to PS2, the information display object (three-dimensional object) is disposed within the object space at the depth position Z2 close to the screen SC.

Alternatively, a texture of the information display object may be mapped onto a semitransparent (transparent) polygon (polygon having the screen size), and the depth position of the polygon may be changed corresponding to the parallax level. For example, when the parallax level has been set to PS1, the polygon having the screen size on which the information display object is drawn is disposed at the depth position Z1. When the parallax level has been set to PS2, the polygon having the screen size on which the information display object is drawn is disposed at the depth position Z2.

In FIGS. 4 and 6, the depth positions of the information display objects HDL and HDR change in an identical manner corresponding to a change in parallax level. Note that the depth positions of the information display objects HDL and HDR change in a different manner corresponding to a change in parallax level. For example, when the parallax level PS has been set to PS1, the information display object HDR may be stereoscopically displayed at a depth position in front of or behind the information display object HDL. For example, the depth position when the parallax level is set to the maximum value may differ between the information display objects. In this case, since the depth position corresponding to each parallax level differs between the information display objects, the information can be presented in a more ordered manner, for example.

FIGS. 7 to 9 show examples of a game image generated using the method according to one embodiment of the invention. FIGS. 7 to 9 show examples in which the method according to one embodiment of the invention is applied to a portable game device. The portable game device can implement naked-eye stereoscopic display, for example. More specifically, an optical system (i.e., an optical system that provides light (rays) with directivity (e.g., parallax barrier) is provided in a liquid crystal display panel that forms the display section 190 to implement naked-eye stereoscopic display.

The portable game device is provided with the slide switch 10 for adjusting the parallax level (stereoscopic level). The parallax level increases when the slide switch 10 is moved upward, and decreases when the slide switch 10 is moved downward.

FIG. 7 shows an example of a game image that is displayed when the parallax level has been set to the maximum value (i.e., the slide switch 10 has been moved to the uppermost position). An airplane (i.e., character) object OBF and a background object OBM are displayed on the display section 190 as the main display objects. Information display objects HDL1, HDL2, HDR1, and HDR2 are displayed near the left side or the right side of the screen. The information display objects HDL1, HDL2, HDR1, and HDR2 present information (e.g., the altitude of the airplane, the number of available missiles, and the angle of the airplane) to the player.

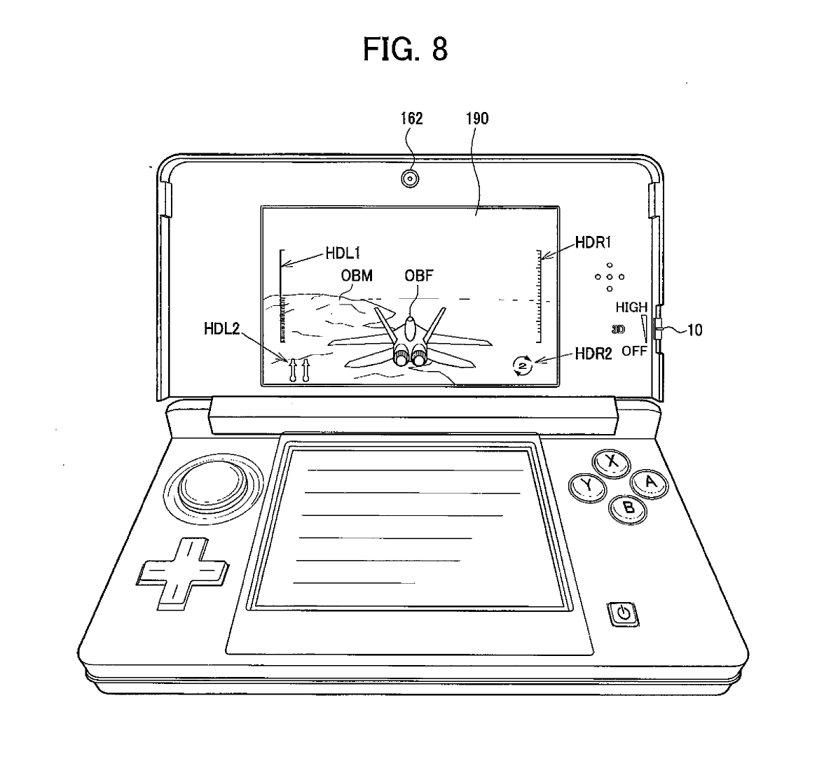

FIG. 8 shows an example of a game image that is displayed when the parallax level has been reduced (i.e., the slide switch 10 has been moved downward) as compared with FIG. 7. In FIG. 8, the left information display objects HDL1 and HDL2 are displayed at positions closer to the left side of the screen of the display section 190 as compared with FIG. 7, and the right information display objects HDR1 and HDR2 are displayed at positions closer to the right side of the screen as compared with FIG. 7.

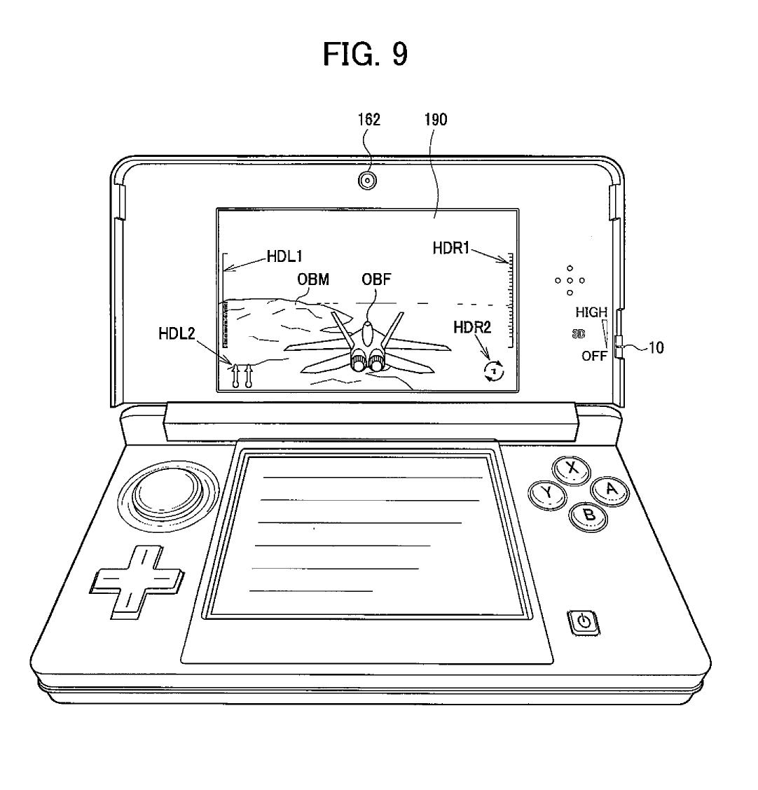

FIG. 9 shows an example of a game image that is displayed when the parallax level has been set to zero (i.e., the slide switch 10 has been moved to the lower'most position). In FIG. 9, the left information display objects HDL1 and HDL2 are displayed at positions closer to the left side of the screen of the display section 190 as compared with FIG. 8, and the right information display objects HDR1 and HDR2 are displayed at positions closer to the right side of the screen as compared with FIG. 8.

A stereoscopic image is thus generated so that the display position of the information display object approaches either side (left side or right side) of the screen of the display section 190 when the parallax level has been set to a small value (second parallax level) as compared with the case where the parallax level has been set to a large value (first parallax level).

According to one embodiment of the invention, the information display object can be displayed near to the left side or the right side of the screen of the display section 190 (see FIGS. 7, 8, and 9). This makes it possible to provide a sufficiently large display area for the airplane object OBF and the background object OBM (i.e., main display objects), so that an ordered game screen convenient to the player can be displayed.

According to the comparative example shown in FIG. 5, an unnecessary space (see B1 and B2) is formed near the left side or the right side of the screen when the parallax level has been set to zero.

When using the method according to one embodiment of the invention, the information display object is displayed at a position close to the left side or the right side of the screen even when the parallax level has been set to zero (see FIG. 9). This makes it possible to prevent a situation in which an unnecessary space is formed near the left side or the right side of the screen.

2.2 Determination of Display Position of Information Display Object

The display position of the information display object may be determined as described below when the parallax level has changed.

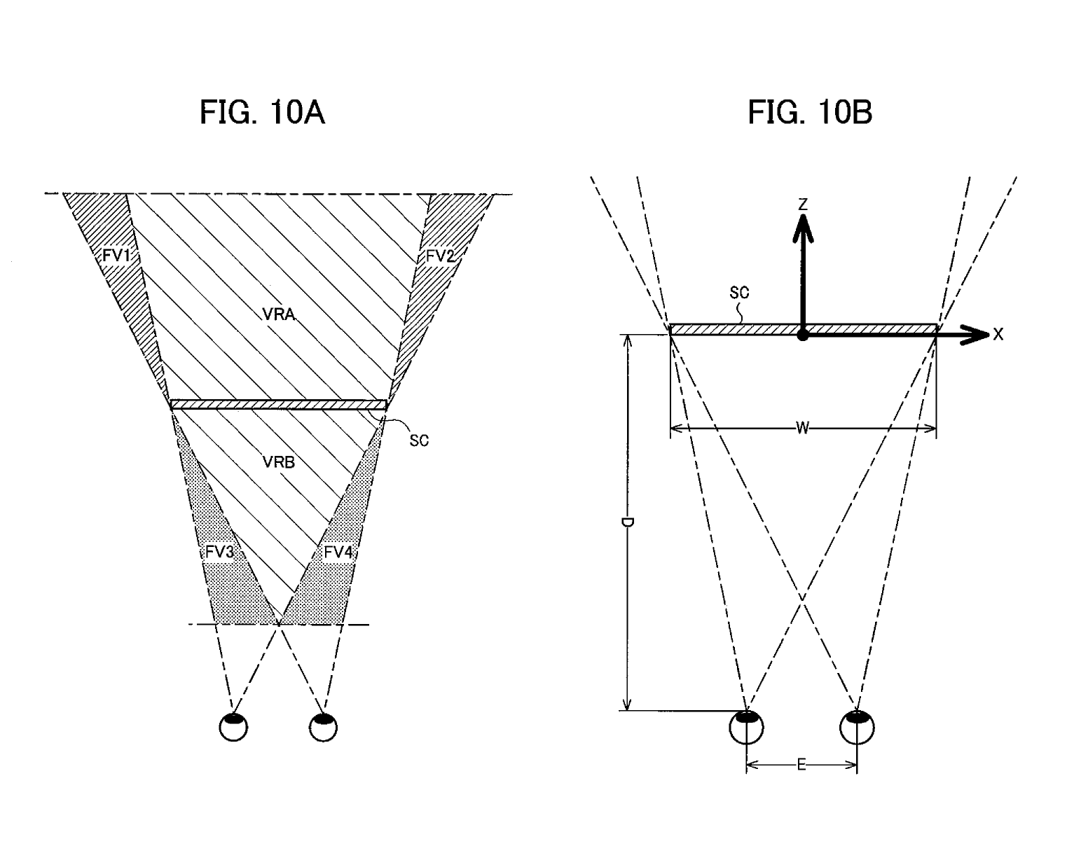

Areas FV1, FV2, FV3, and FV4 shown in FIG. 10A are referred to as frame violation areas. The frame violation areas FV1 and FV2 are referred to as rear frame violation areas, and the frame violation areas FV3 and FV4 are referred to as front frame violation areas. The term “frame violation area” refers to an area that can be observed with either eye.

The rear frame violation areas FV1 and FV2 may occur in the real world when seeing a view from a window with a frame that corresponds to the screen, for example. Specifically, the rear frame violation areas FV1 and FV2 can be observed in an almost natural way. Since the front frame violation areas FV3 and FV4 are positioned in front of the screen, but can be observed with either eye, the front frame violation areas FV3 and FV4 are hard to observe.

In one embodiment of the invention, the areas FV1, FV2, FV3, and FV4 are collectively handled as the frame violation areas.

Since it is difficult to observe a display object that is disposed in the rear frame violation area (FV1 and FV2) or the front frame violation area (FV3 and FV4), it is not desirable to dispose the information display object that displays important information in the frame violation areas. In one embodiment of the invention, the information display object is disposed in a non-frame violation area VRA or VRB so that the information display object can be easily observed.

A coordinate system is set as shown in FIG. 10B. A unit (e.g., mm) in a real space is used.

A case where the information display object is disposed behind the screen (SC) is described below.

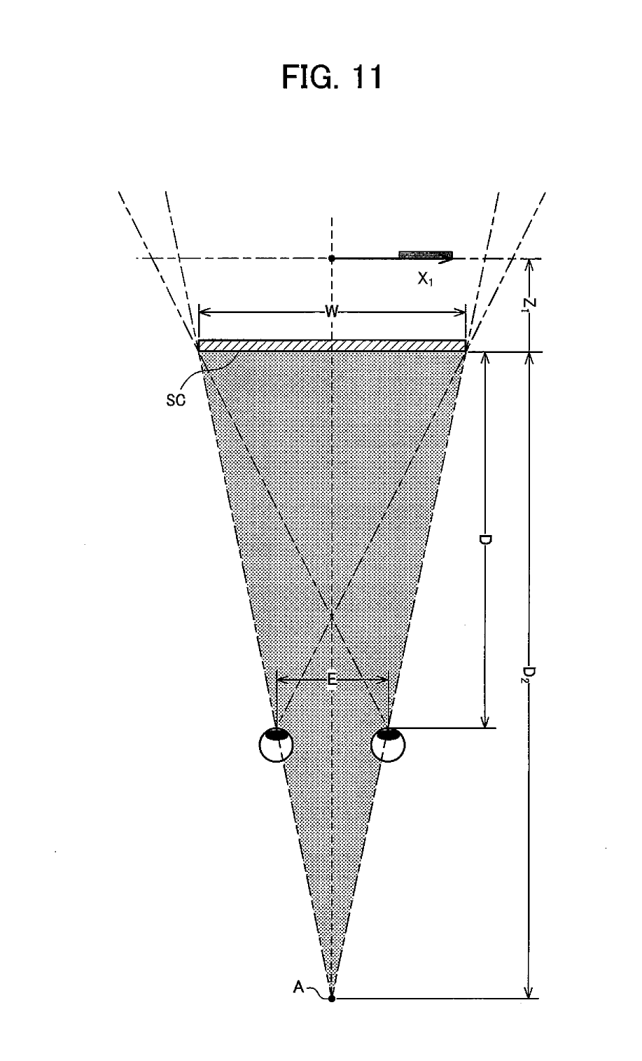

As shown in FIG. 11, the intersection point of the left edge (side) (i.e., a line that corresponds to the left clipping plane) of the left-eye view volume (left-eye view frustum) and the right edge (side) (i.e., a line that corresponds to the right clipping plane) of the right-eye view volume is referred to as A. The distance D₂ between the intersection point A and the screen is calculated by the following expression (2) using the following expression (1).

W:D₂=E:D₂−D (1)

$${D}_{2} = \frac{W}{W - E} D \qquad ( 2 )$$

Note that D is the distance between the left and right eyes and the screen, W is the width of the screen, and E is the inter-viewpoint distance between the left eye and the right eye.

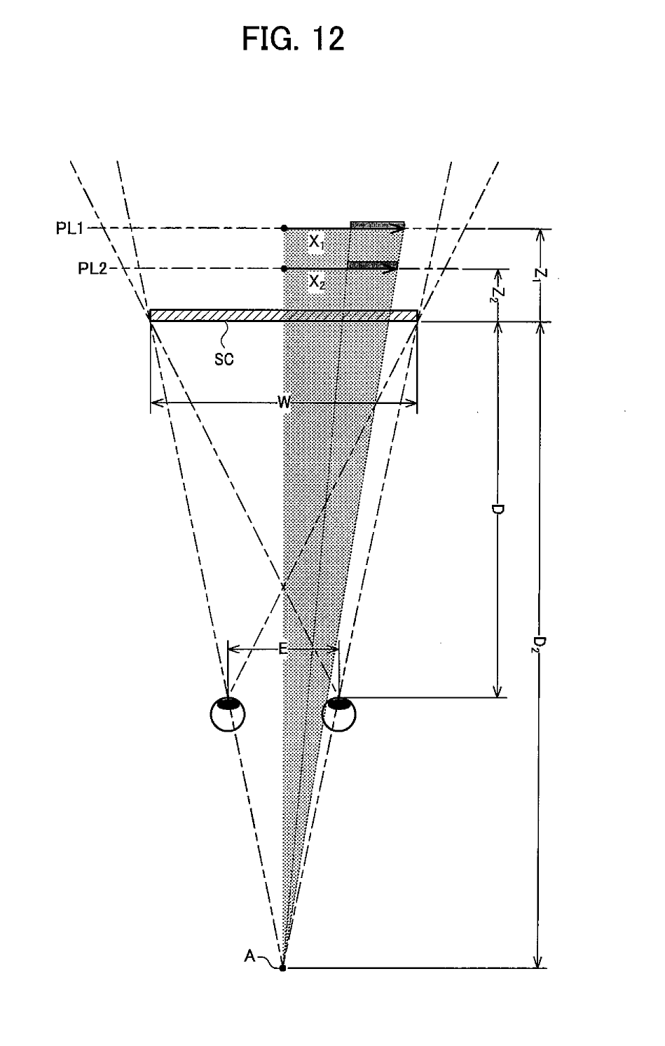

As shown in FIG. 12, the X-axis position of the right end of the information display object when the parallax level is set to the maximum value and the Z-axis position (depth position) of the information display object is Z=Z₁ is referred to as X₁. The X-axis position of the right end of the information display object when the Z-axis position of the information display object is Z=Z₂ is referred to as X₂. The relationship between the X-axis position X₁ and X-axis position X₂ is shown by the following expression (4) using the expression (2) and the following expression (3).

X₁:D₂+Z₁=X₁:D₂+Z₂+Z₂ (3)

$${X}_{2} = \frac{{D}_{2} + {Z}_{2}}{{D}_{2} + {Z}_{1}} {X}_{1} = \frac{WD + ( W - E ) {Z}_{2}}{WD + ( W - E ) {Z}_{1}} {X}_{1} \qquad ( 4 )$$

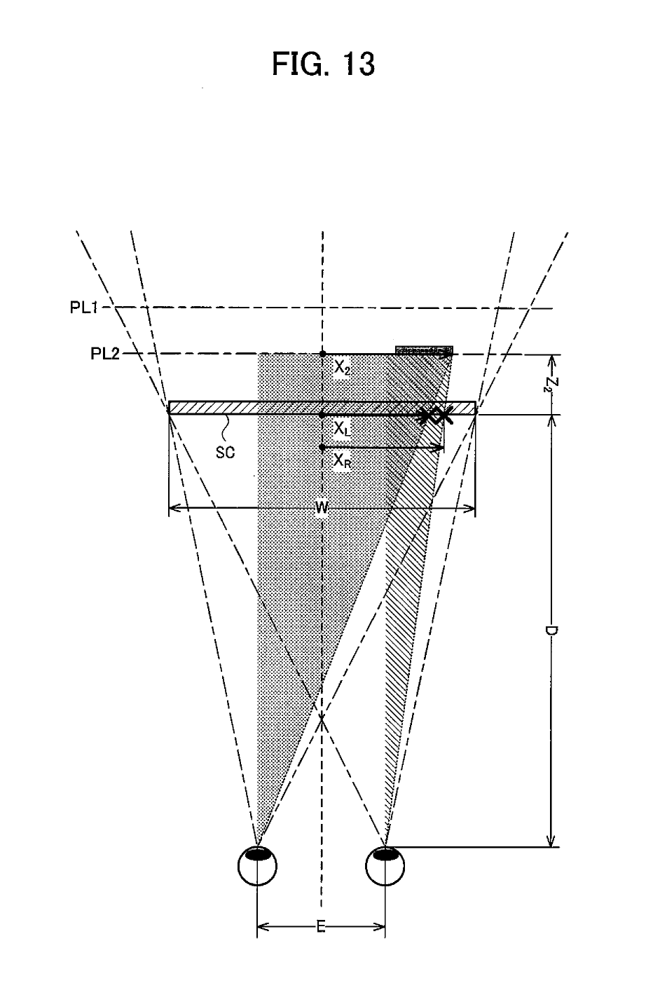

The display position X_{L} (see FIG. 13) of the X-axis position X₂ within the screen (SC) in the left-eye image is calculated by the following expression (6) using the following expression (5).

X₂+E/2:D+Z₂=X_{L}+E/2:D (5)

$${X}_{L} = \frac{{X}_{2} D - {Z}_{2} E / 2}{D + {Z}_{2}} \qquad ( 6 )$$

Likewise, the display position X_{R} of the X-axis position X₂ within the screen in the right-eye image is calculated by the following expression (8) using the following expression (7).

X₂+E/2:D+Z₂=X_{L}−E/2:D (7)

$${X}_{R} = \frac{{X}_{2} D + {Z}_{2} E / 2}{D + {Z}_{2}} \qquad ( 8 )$$

The coordinate value (−1 to +1) with respect to the width of the screen can be calculated by dividing the display position X_{L} and the display position X_{R} by W/2. When the coordinate value is referred to as x, and the number of pixels in the transverse direction is referred to as p, the pixel-unit position can be calculated by calculating “x×p/2+p/2”.

A stereoscopic image so that the information display object is stereoscopically displayed at the corresponding depth position can be generated by drawing the left-eye image so that the right end of the sprite of the information display object is positioned at the display position X_{L}, and drawing the right-eye image so that the right end of the sprite of the information display object is positioned at the display position X_{R}. Specifically, a stereoscopic image can be generated by causing the display position of the information display object within the screen to differ between the left-eye image (first-viewpoint image) and the right-eye image (second-viewpoint image).

A case where the information display object is disposed in front of the screen (SC) is described below.

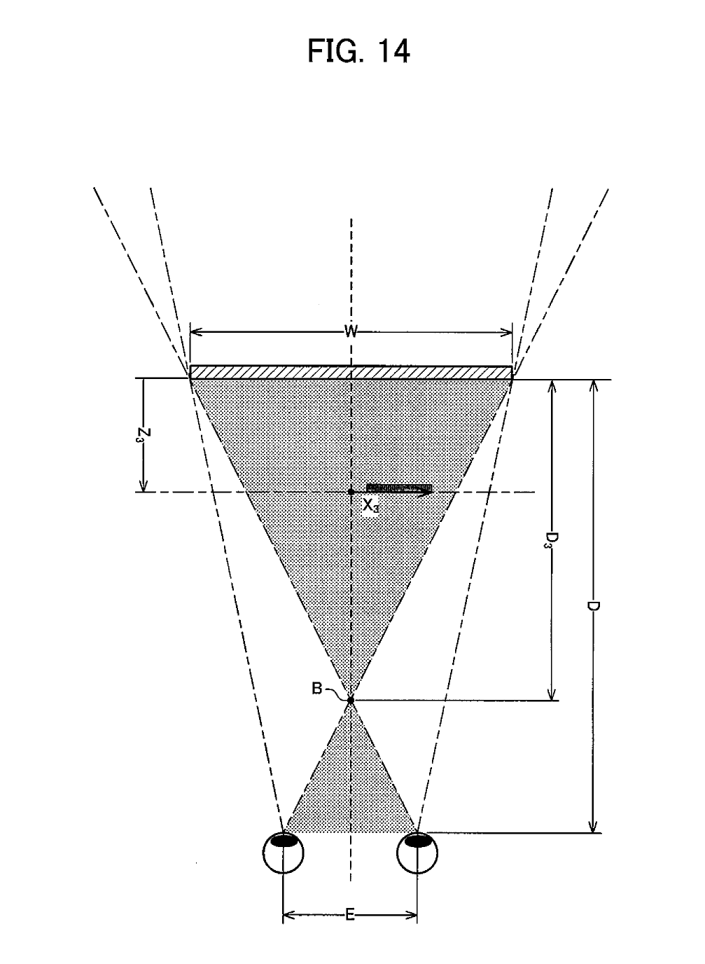

As shown in FIG. 14, the intersection point of the right edge (side) of the left-eye view volume and the left edge (side) of the right-eye view volume is referred to as B. The distance D₃ between the intersection point B and the screen is calculated by the following expression (10) using the following expression (9).

W:D₃=E:D−D₃ (9)

$${D}_{3} = \frac{W}{W + E} D \qquad ( 10 )$$

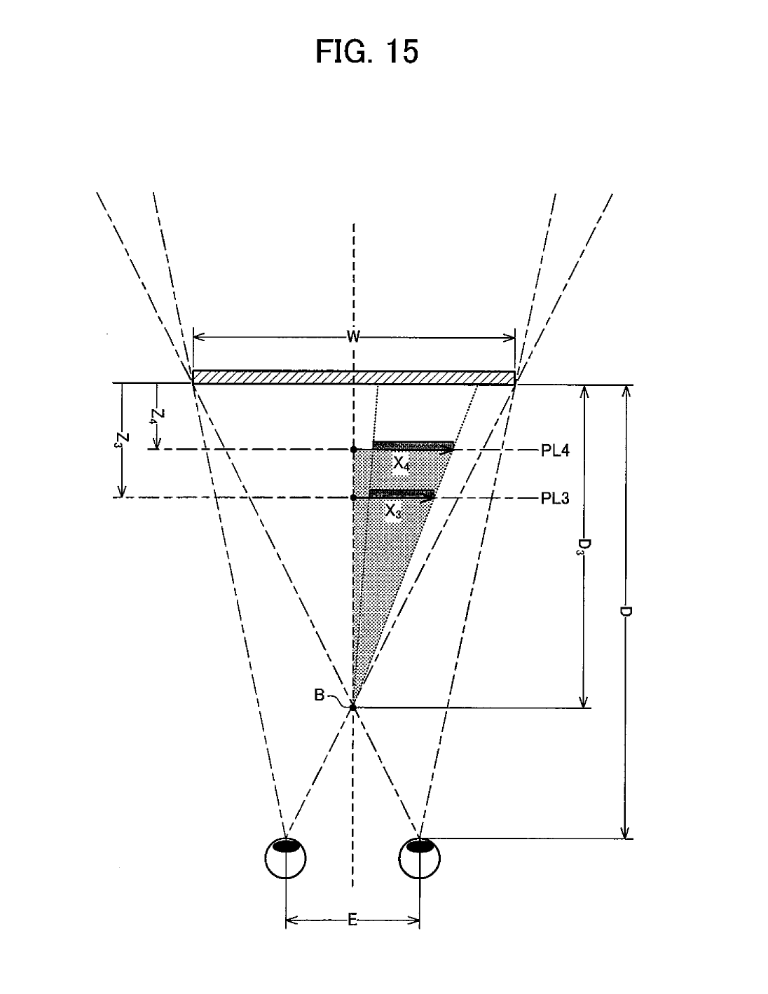

As shown in FIG. 15, the X-axis position of the right end of the information display object when the parallax level is set to the maximum value and the Z-axis position of the information display object is Z=Z₃ (Z₃<0) is referred to as X₃. The X-axis position of the right end of the information display object when the Z-axis position of the information display object is Z=Z₄ (Z₄<0) is referred to as X₄. The relationship between the X-axis position X₃ and X-axis position X₄ is shown by the following expression (12) using the expression (10) and the following expression (11).

X₃:D₃+Z₃=X₄:D₃+Z₄ (11)

$${X}_{4} = \frac{{D}_{3} + {Z}_{4}}{{D}_{3} + {Z}_{3}} {X}_{3} = \frac{WD + ( W + E ) {Z}_{4}}{WD + ( W + E ) {Z}_{3}} {X}_{3} \qquad ( 12 )$$

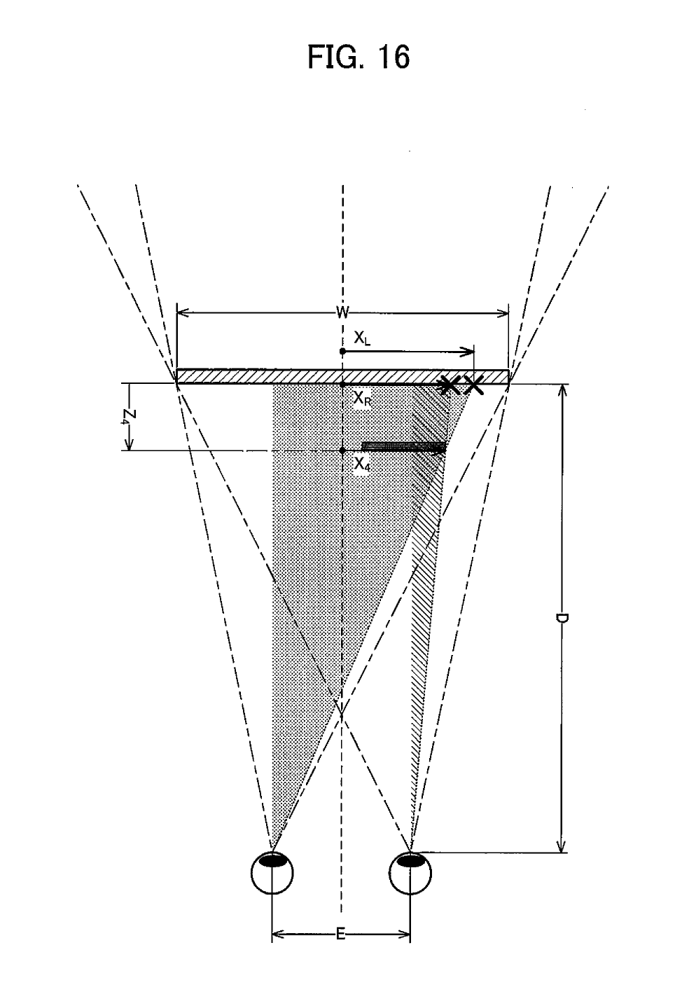

The display position X_{L} (see FIG. 16) of the X-axis position X₄ within the screen in the left-eye image is calculated by the following expression (14) using the following expression (13).

X₄+E/2:D+Z₄=X_{L}+E/2:D (13)

$${X}_{L} = \frac{{X}_{4} D - {Z}_{4} E / 2}{D + {Z}_{4}} \qquad ( 14 )$$

Likewise, the display position X_{R} of the X-axis position X₄ within the screen in the right-eye image is calculated by the following expression (16) using the following expression (15).

X₄+E/2:D+Z₄=X_{R}−E/2:D (15)

$${X}_{R} = \frac{{X}_{4} D + {Z}_{4} E / 2}{D + {Z}_{4}} \qquad ( 16 )$$

A stereoscopic image so that the information display object is stereoscopically displayed at the corresponding depth position can be generated even if the information display object is disposed in front of the screen, by drawing the left-eye image so that the right end of the sprite of the information display object is positioned at the display position X_{L}, and drawing the right-eye image so that the right end of the sprite of the information display object is positioned at the display position X_{R}.

Note that the display state (e.g., hue, brightness, intensity, translucency, blur level, and visual effect) of the information display object may be changed corresponding to the parallax level.

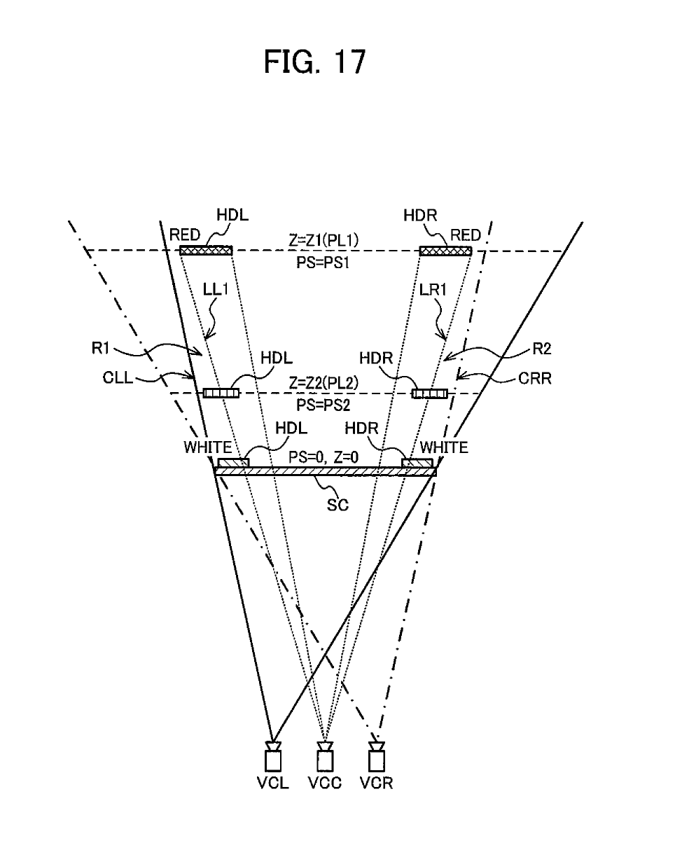

In FIG. 17, the color of the information display objects HDL and HDR is set to white when the parallax level is set to zero. The display state of the information display objects HDL and HDR is changed as the parallax level increases (e.g., the color of the information display objects HDL and HDR is gradually changed to red). Specifically, the display state of the information display objects HDL and HDR differs between the case where the parallax level has been set to PS=PS1 (first parallax level) and the case where the parallax level has been set to PS=PS2 (second parallax level).

This makes it possible for the player to become visually aware of a change in parallax level due to a change in the display state (e.g., color) of the information display object in addition to a change in the depth position of the information display object. Therefore, it is possible to display the information display object so that the information display object can be easily observed and the information can be easily ordered, as compared with the case of changing only the depth position of the information display object. This makes it possible to provide a player-friendly interface environment.

Note that the display state of the information display object may be changed in various ways instead of changing the color of, the information display object (see FIG. 17). For example, the brightness, the translucency or the blur level of the information display object may be changed when the parallax level has changed, or a texture that is mapped onto the information display object may be changed when the parallax level has changed. Alternatively, a visual effect applied to the information display object may be changed when the parallax level has changed. For example, the animation of the information display object may be changed, or the display state of a visual effect object that is displayed together with the information display object may be changed.

2.3 Application of Multi-View Stereovision and the Like

Although an example in which the method according to one embodiment of the invention is applied to binocular stereovision has been described above, the method according to one embodiment of the invention may also be applied to multi-view stereovision, spatial imaging stereovision, and the like. Multi-view stereovision is implemented by a discrete multi-view stereoscopic method that makes it possible to implement stereovision from arbitrary viewpoints of the player (observer). For example, stereovision at an arbitrary viewpoint is implemented by providing a plurality of viewpoint images (parallax images), and allowing the player to observe viewpoint images among the plurality of viewpoint images corresponding to the viewpoint positions of the player with the left eye and the right eye. Such multi-view stereovision may be implemented by a stereoscopic method using an optical element (e.g., parallax barrier or lenticular lens), or the like. Spatial imaging stereovision is implemented by a stereoscopic method that makes it possible to implement stereovision from a continuous (indiscrete) viewpoint (i.e., a specific viewpoint is not used). A fractional view method, an integral imaging method, a super multi-view method, and the like have been known as a method that implements spatial imaging stereovision.

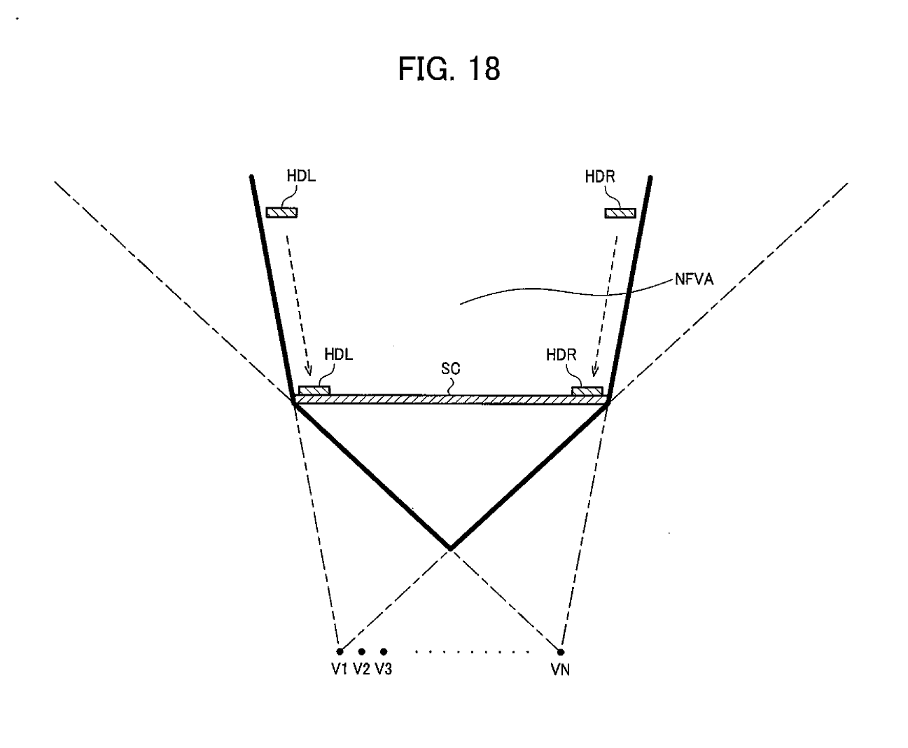

FIG. 18 shows an example in which the method according to one embodiment of the invention is applied to multi-view stereovision or the like. For example, when implementing multi-view stereovision, a non-frame violation area that is set based on the leftmost viewpoint V1 and the rightmost viewpoint VN among a plurality of viewpoints V1 to VN is an area NFVA enclosed by a bold line in FIG. 18. The area NFVA is a common area (common frame area) of a view volume for the viewpoint V1 and a view volume for the viewpoint VN.

In this case, a stereoscopic image is generated so that information display objects HDL and HDR are stereoscopically displayed within the area NFVA even if the parallax level has changed (see FIG. 18).

More specifically, the stereoscopic display position of the information display object HDL is changed along the left clipping plane of the view volume for the viewpoint V1 when the parallax level has changed, as described above with reference to FIG. 4. The stereoscopic display position of the information display object HDR is changed along the right clipping plane of the view volume for the viewpoint VN when the parallax level has changed. This makes it possible to stereoscopically display the information display object so that the player can easily observe the information display object even if the parallax level has changed when implementing multi-view stereovision. This also applies to the case of implementing spatial imaging stereovision. However, when the observation area (turn-around range) displayed at the same time is large (wide) when implementing multi-view stereovision or spatial imaging stereovision, the non-frame violation area may be very small (narrow). In this case, two viewpoints positioned on the inner side of the leftmost and rightmost viewpoints (e.g., the position of each eye when the player is positioned directly in front of the screen) may be used as the viewpoints V1 and V2.

However, the information display object may enter the frame violation area when the player has moved to the right or left. Therefore, when positional relationship information about the viewpoint of the player and the screen can be detected by an eye tracking process (described below) or the like, the viewpoints may be selected based on the positional relationship information, and the information display object may be displayed in an area that corresponds to the selected viewpoints.

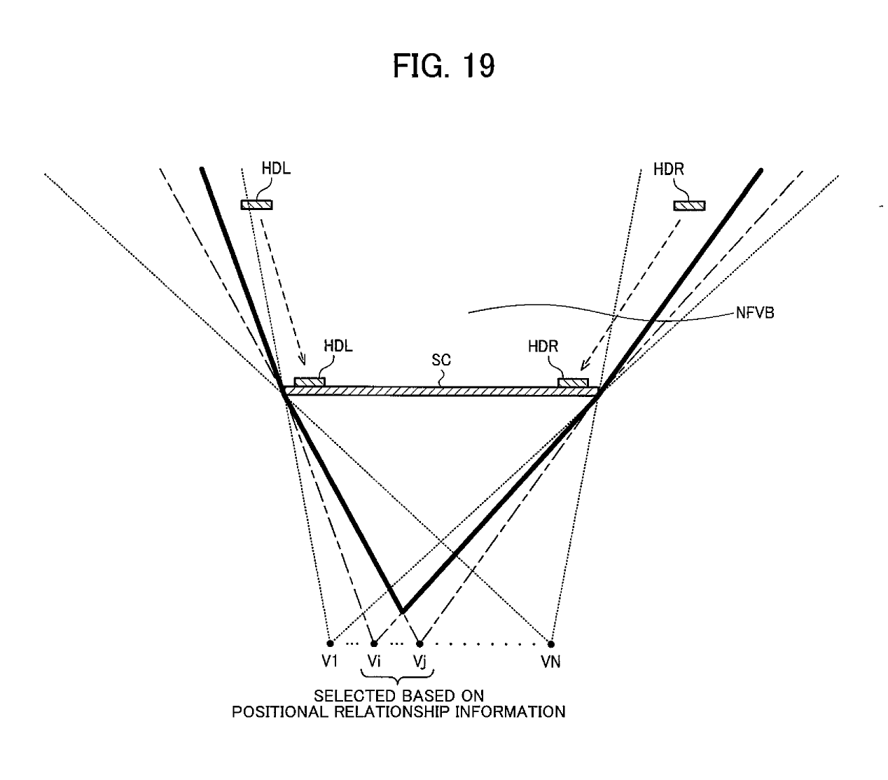

In FIG. 19, the positional relationship information about the screen of the display section and the player (observer) has been acquired, and a first viewpoint Vi and a second viewpoint Vj (that implement multi-view stereovision or spatial imaging stereovision) corresponding to the left eye and the right eye of the player have been selected based on the acquired positional relationship information, for example. A first-viewpoint image viewed from the first viewpoint Vi and a second-viewpoint image viewed from the second viewpoint Vj are generated to generate a stereoscopic image that is observed by the player with the left eye and the right eye.

In FIG. 19, the information display objects HDL and HDR are stereoscopically displayed within a common area NFVB of a view volume that corresponds to the first viewpoint Vi selected based on the positional relationship information and a view volume that corresponds to the second viewpoint Vj selected based on the positional relationship information. For example, a stereoscopic image is generated so that the information display objects HDL and HDR are stereoscopically displayed within the area NFVB even if the parallax level has changed. Specifically, the stereoscopic display position of the information display object is changed corresponding to the parallax level using the method described above with reference to FIGS. 4 and 6.

This makes it possible to set the optimum area NFVB corresponding to the viewpoint position of the player, and change the stereoscopic display (position) of the information display object within the area NFVB even if the parallax level has changed when implementing multi-view stereovision or spatial imaging stereovision. This enables optimum stereoscopic display of the information display object when implementing multi-view stereovision, spatial imaging stereovision, or the like.

An example of a binocular tracking method according to one embodiment of the invention is described in detail below. The binocular tracking method according to one embodiment of the invention is implemented by acquiring the position information about the left eye and the right eye of the player, and selecting viewpoints for multi-view stereovision or spatial imaging stereovision. A normal head tracking method detects the position of the head of the player, and sets the position and the direction of the virtual camera, for example. The binocular tracking method according to one embodiment of the invention detects the positions of the left eye and the right eye of the player.

The positions of the left eye and the right eye of the player may be detected by various methods. For example, the positions of the left eye and the right eye of the player may be detected by performing an eye tracking process using the imaging section (camera).

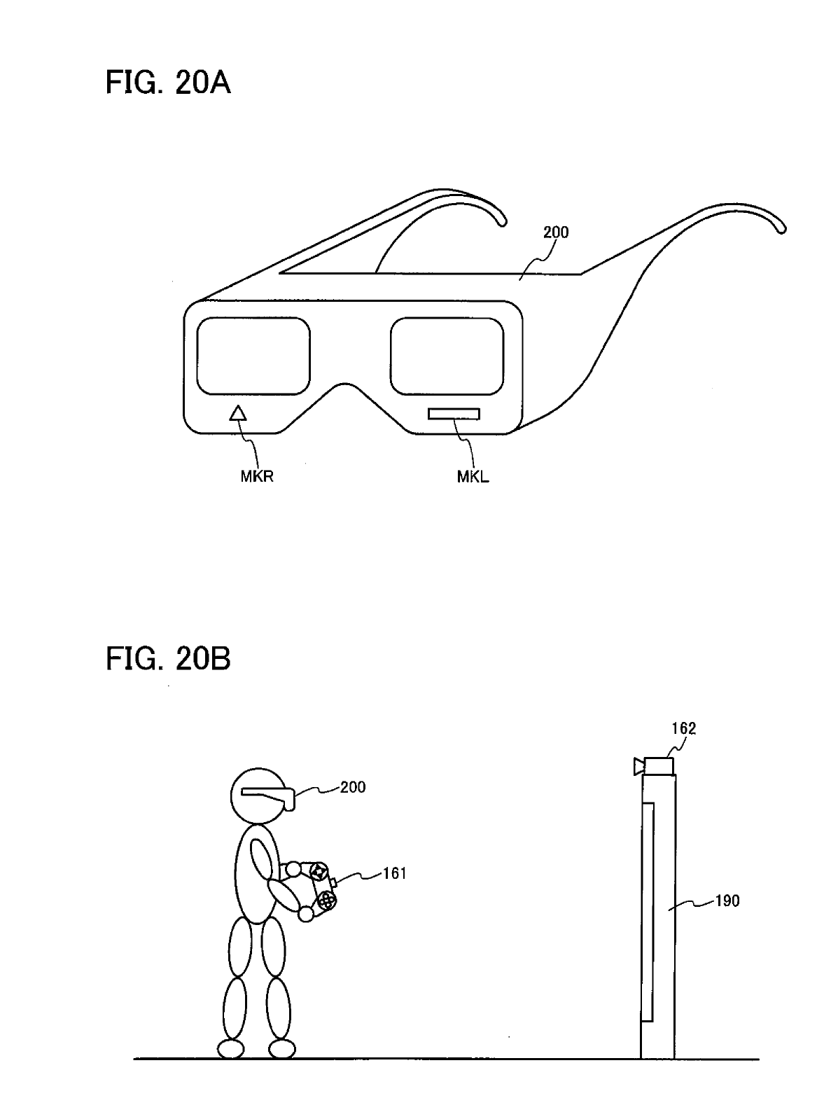

Alternatively, glasses 200 (wearable member in a broad sense) shown in FIG. 20A are provided, and a left-eye marker MKL corresponding to the left eye of the player and a right-eye marker MKR corresponding to the right eye of the player are provided to the glasses 200. Specifically, the left-eye marker MKL is provided to the glasses 200 at a position corresponding to the left-eye part, and the right-eye marker MKR is provided to the glasses 200 at a position corresponding to the right-eye part. The left-eye marker MKL and the right-eye marker MKR differ in shape.

As shown in FIG. 20B, the position information about the left eye and the right eye of the player is acquired based on the imaging information from the imaging section 162 that images the glasses 200 (recognition member) worn by the player. Specifically, the imaging section 162 that images the player from the display section 190 is provided. The player is imaged using the imaging section 162, and the shape of the left-eye marker MKL and the shape of the right-eye marker MKR (see FIG. 20A) are recognized by performing an image recognition process on the imaging information. The positions of the left eye and the right eye of the player when viewed from the display section 190 are detected based on the image recognition results.

The first viewpoint Vi and the second viewpoint Vj are selected using the positions of the left eye and the right eye of the player as the positional relationship information (see FIG. 19), and the common area NFVB of the view volume that corresponds to the first viewpoint Vi and the view volume that corresponds to the second viewpoint Vj is set. A stereoscopic image is generated so that the information display objects HDL and HDR that present information to the player are stereoscopically displayed within the common area NFVB even if the parallax level or the like has changed.

A stereoscopic image of the information display object when implementing multi-view stereovision of spatial imaging stereovision can thus be advantageously generated using the optimum viewpoints selected by performing the binocular tracking process on the player.

2.4 Modification

An example in which the information display object has a planar shape that is parallel to the screen has been described above. Note that another configuration may also be employed.

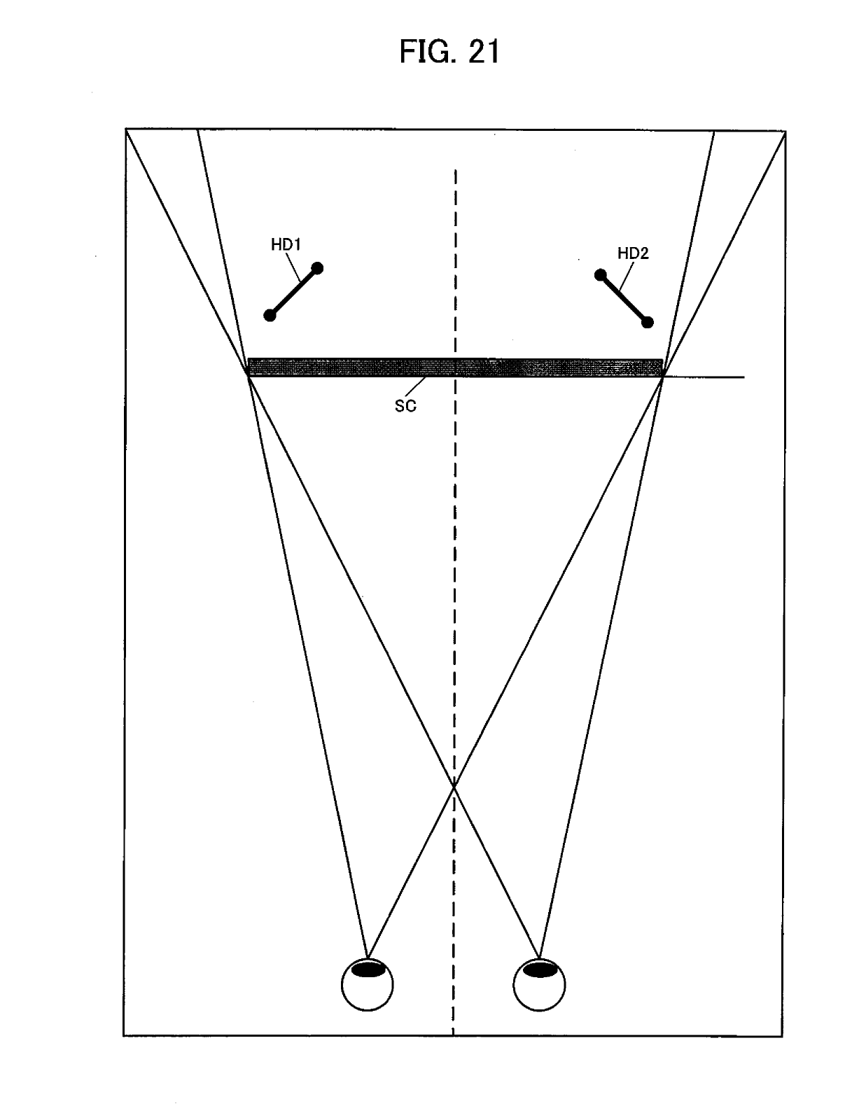

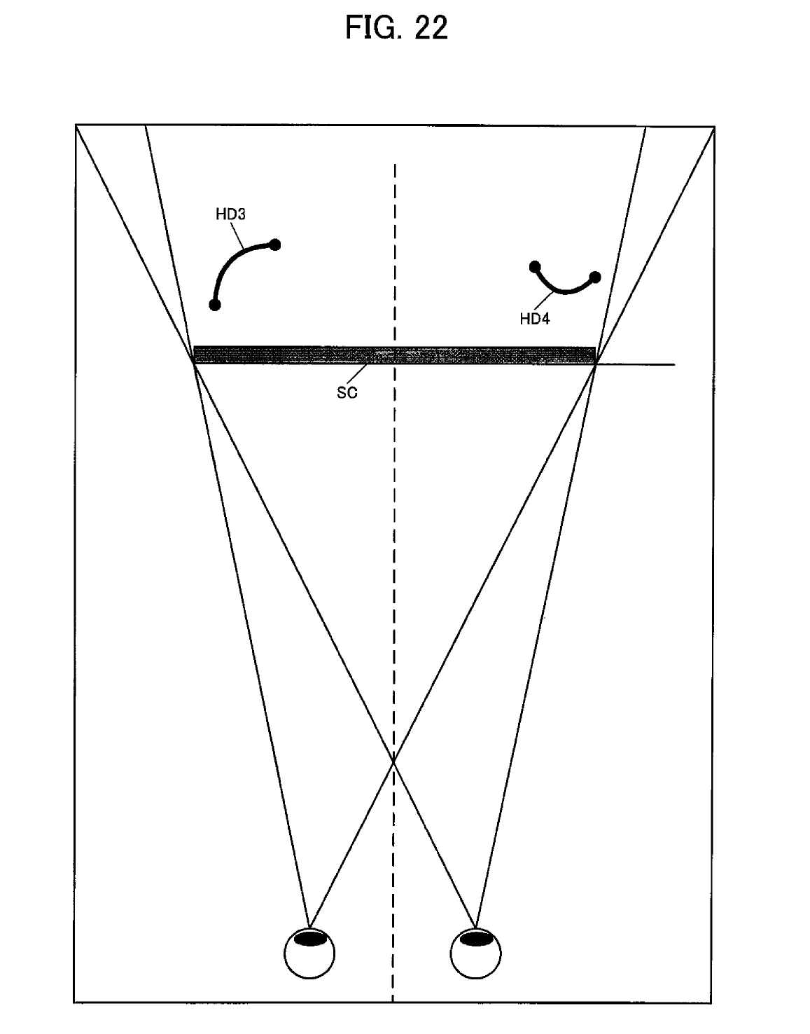

For example, FIG. 21 shows information display objects HD1 and HD2 that are disposed non-parallel to the screen SC, and FIG. 22 shows information display objects HD3 and HD4 having a curved shape. Such information display objects may also be used. Such information display objects may be displayed by disposing a polygon model of the information display object in a 3D space similar to that of a normal 3D object, and drawing an image. The information display object can be displayed so that the information display object does not enter the frame violation area, but is positioned near the edge as much as possible, by calculating the positions of the left end and right end of each information display object when the parallax level has been reduced in the same manner as described above, and displaying each information display object in the same manner as other 3D objects at a position shifted based on the calculation results.

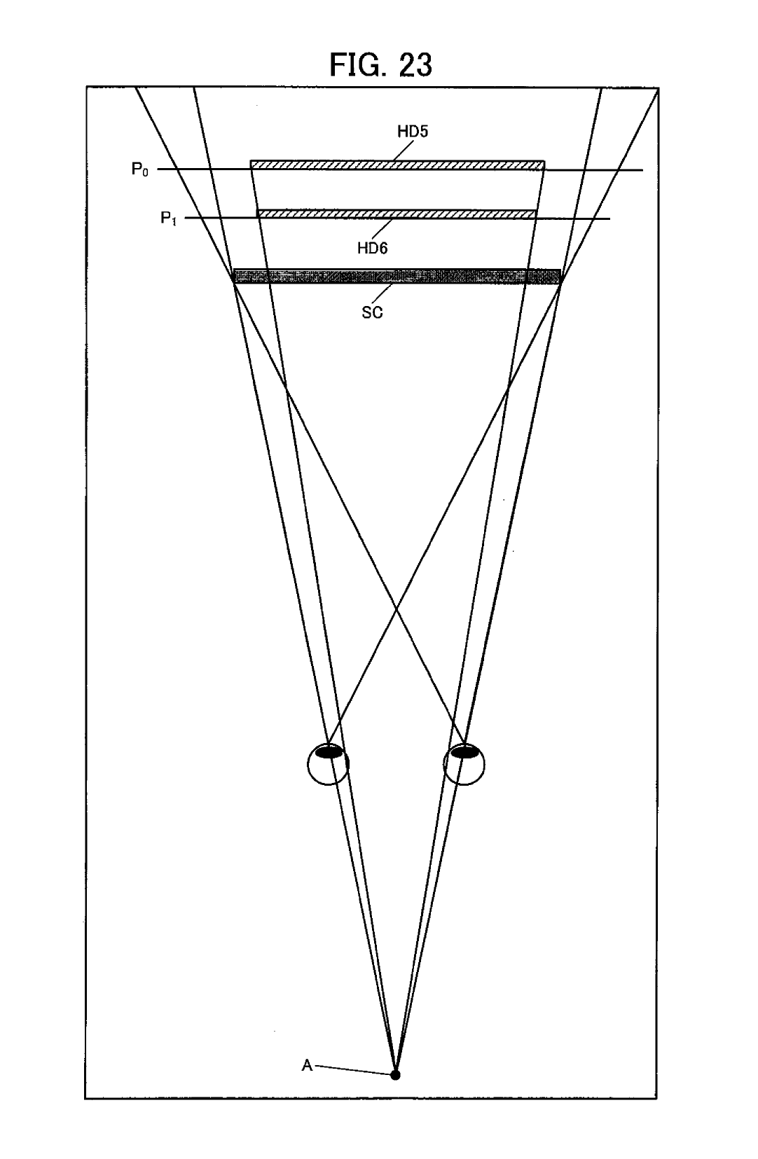

FIG. 23 shows information display objects HD5 and HD6 (e.g., subtitle) having a large width. In this case, the positions of the left end and the right end of the information display objects HD5 and HD6 are calculated in the same manner as described above, and the information display objects HD5 and HD6 are displayed using the calculated positions. Note that the width of the information display object with respect to the screen when viewed from the position of the observer appears to increase as the parallax level decreases. Specifically, the ratio of the height to the width of the information display object changes when the parallax level has been reduced. Therefore, an information display object for which it is important to maintain the ratio of the height to the width of the information display object may be increased in height so that the ratio of the height to the width of the information display object is maintained. The information display object need not be increased in height when it is not important to maintain the ratio of the height to the width of the information display object.

2.5 Specific Processing Example

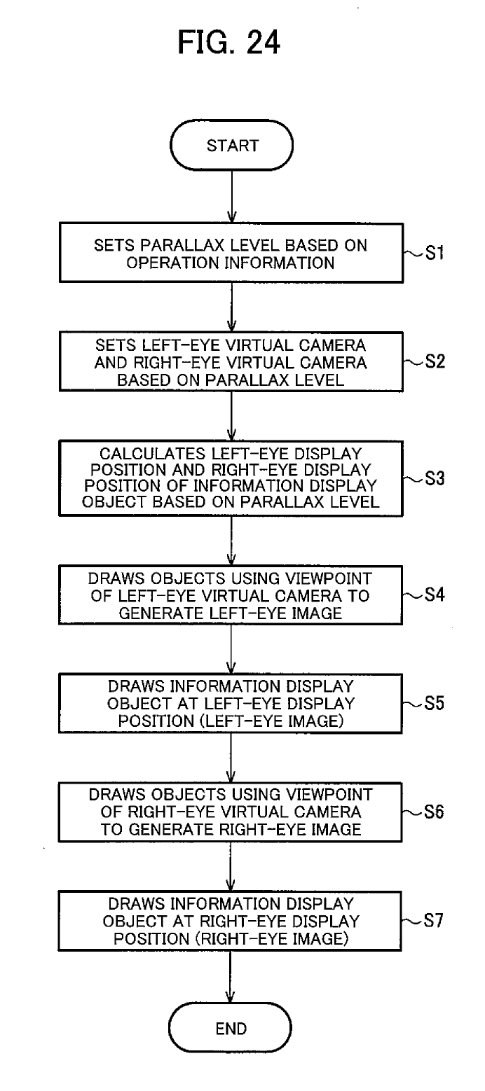

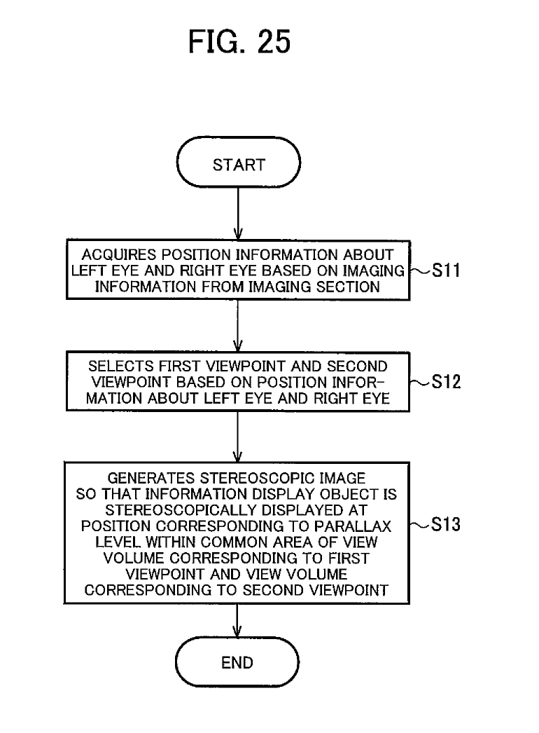

A specific processing example according to one embodiment of the invention is described below using flowcharts shown in FIGS. 24 and 25.

FIG. 24 is a flowchart showing a specific processing example of the method according to one embodiment of the invention described above with reference to FIGS. 4 to 16 and the like.

The parallax level is set based on the operation information (step S1). For example, the parallax level is set based on the sliding amount of the slide switch 10 shown in FIGS. 7 to 9. The left-eye virtual camera and the right-eye virtual camera are set based on the parallax level (step S2). For example, the inter-camera distance between the left-eye virtual camera and the right-eye virtual camera is set. The left-eye display position and the right-eye display position of the information display object is calculated based on the parallax level (step S3). For example, the left-eye display position and the right-eye display position of the information display object is calculated using the method described above with reference to FIGS. 10A to 16.

The objects are drawn using the viewpoint of the left-eye virtual camera to generate a left-eye image (step S4). Specifically, the main display objects (e.g., character and background) are drawn using the viewpoint of the left-eye virtual camera to generate a left-eye image. The information display object (e.g., sprite) is drawn at the left-eye display position (left-eye image) calculated in the step S3 (step S5). The objects are drawn using the viewpoint of the right-eye virtual camera to generate a right-eye image (step S6). Specifically, the main display objects (e.g., character and background) are drawn using the viewpoint of the right-eye virtual camera to generate a right-eye image. The information display object (e.g., sprite) is drawn at the right-eye display position (right-eye image) calculated in the step S3 (step S7).

FIG. 25 is a flowchart showing a specific processing example of the method according to one embodiment of the invention described above with reference to FIGS. 19 to 20B.

The position information about the left eye and the right eye of the player is acquired based on the imaging information from the imaging section, as described above with reference to FIGS. 20A and 20B (step S11). The first viewpoint and the second viewpoint when implementing multi-view stereovision or spatial imaging stereovision are selected based on the position information about the left eye and the right eye of the player (step S12).

A stereoscopic image is generated so that the information display object is stereoscopically displayed at a position corresponding to the parallax level within the common area of the view volume that corresponds to the first viewpoint and the view volume that corresponds to the second viewpoint, as described above with reference to FIG. 19 (step S13).

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., glasses) cited with a different term (e.g., recognition member) having a broader meaning or the same meaning at least once in the specification and the drawings can be replaced by the different term in any place in the specification and the drawings. The parallax level setting process, the process that generates the first-viewpoint image and the second-viewpoint image, the process that sets the depth position of the information display object, the process that generates the stereoscopic image of the information display object, the viewpoint selection process, and the like are not limited to those described in connection with the above embodiments. Methods equivalent to the above methods are included within the scope of the invention. The invention may be applied to various games. The invention may be applied to various image generation systems such as an arcade game system, a consumer game system, a large-scale attraction system in which a number of players participate, a simulator, a multimedia terminal, a system board that generates a game image, and a mobile phone.

What is claimed is:

1. An image generation system comprising:
a parallax level setting section that sets a parallax level of stereovision; and
an image generation section that generates a first-viewpoint image viewed from a first viewpoint and a second-viewpoint image viewed from a second viewpoint to generate a stereoscopic image, the first viewpoint and the second viewpoint implementing stereovision,
the image generation section generating the stereoscopic image so that an information display object that presents information to an observer is stereoscopically displayed at a first depth position that is behind or in front of a screen when the parallax level has been set to a first parallax level, and the information display object is stereoscopically displayed at a second depth position that is closer to the screen than the first depth position when the parallax level has been set to a second parallax level that is lower than the first parallax level, and
the image generation section generating the stereoscopic image so that a first edge of the information display object is stereoscopically displayed within a first area when the parallax level has been set to the second parallax level, the first edge being a left edge or a right edge of the information display object, a first boundary plane being a boundary plane specified by a line segment that connects the first edge and a third viewpoint when the parallax level has been set to the first parallax level, the third viewpoint being positioned between the first viewpoint and the second viewpoint, a first clipping plane being either clipping plane of a view volume that corresponds to the first viewpoint or a view volume that corresponds to the second viewpoint, and the first area being an area positioned between the first boundary plane and the first clipping plane.

2. The image generation system as defined in claim 1,
the image generation section generating the stereoscopic image so that the information display object is stereoscopically displayed within the first area at a depth position of the screen when the parallax level has been set to zero.

3. The image generation system as defined in claim 1,
the image generation section generating the stereoscopic image so that a display position of the information display object when the parallax level has been set to the second parallax level is closer to either side of a screen of a display section as compared with a case where the parallax level has been set to the first parallax level.

4. The image generation system as defined in claim 1,
the parallax level setting section setting the parallax level based on operation information from an operation section operated by the observer.

5. The image generation system as defined in claim 1,
the image generation section generating the stereoscopic image by causing a display position of the information display object within the screen to differ between the first-viewpoint image and the second-viewpoint image.

6. The image generation system as defined in claim 1,
the information display object being a display object that presents game status information, information about a character that appears in a game, game result information, guide information, or character information to the observer.

7. The image generation system as defined in claim 1,
the image generation section changing a display state of the information display object depending on whether the parallax level has been set to the first parallax level or the second parallax level.

8. The image generation system as defined in claim 1,
the first viewpoint and the second viewpoint respectively being a viewpoint of a left-eye virtual camera and a viewpoint of a right-eye virtual camera that implement binocular stereovision.

9. The image generation system as defined in claim 1,
the first viewpoint and the second viewpoint being two viewpoints among a plurality of viewpoints that implement multi-view stereovision, or two arbitrary viewpoints within an observation range that is set to implement spatial imaging stereovision.

10. The image generation system as defined in claim 9, further comprising:
an information acquisition section that acquires positional relationship information about a screen of a display section and the observer; and
a viewpoint selection section that selects the first viewpoint and the second viewpoint that implement the multi-view stereovision or the spatial imaging stereovision based on the acquired positional relationship information.

11. An image generation system comprising:
an information acquisition section that acquires positional relationship information about a screen of a display section and an observer;
a viewpoint selection section that selects a first viewpoint and a second viewpoint that implement multi-view stereovision or spatial imaging stereovision based on the acquired positional relationship information; and
an image generation section that generates a first-viewpoint image viewed from the first viewpoint and a second-viewpoint image viewed from the second viewpoint to generate a stereoscopic image,
the image generation section generating the stereoscopic image so that an information display object that presents information to the observer is stereoscopically displayed within a common area of a view volume that corresponds to the first viewpoint selected based on the positional relationship information and a view volume that corresponds to the second viewpoint selected based on the positional relationship information.

12. The image generation system as defined in claim 11,
the information acquisition section acquiring position information about a left eye and a right eye of the observer as the positional relationship information, and
the viewpoint selection section selecting the first viewpoint and the second viewpoint based on the position information about the left eye and right eye of the observer.

13. The image generation system as defined in claim 12,
the information acquisition section acquiring the position information about the left eye and the right eye of the observer based on imaging information from an imaging section that images a left-eye marker corresponding to the left eye of the observer and a right-eye marker corresponding to the right eye of the observer.

14. An image generation method that sets a parallax level of stereovision, and generates a first-viewpoint image viewed from a first viewpoint and a second-viewpoint image viewed from a second viewpoint to generate a stereoscopic image, the first viewpoint and the second viewpoint implementing stereovision, the image generation method comprising:
generating the stereoscopic image so that an information display object that presents information to an observer is stereoscopically displayed at a first depth position that is behind or in front of a screen when the parallax level has been set to a first parallax level, and the information display object is stereoscopically displayed at a second depth position that is closer to the screen than the first depth position when the parallax level has been set to a second parallax level that is lower than the first parallax level; and
generating the stereoscopic image so that a first edge of the information display object is stereoscopically displayed within a first area when the parallax level has been set to the second parallax level, the first edge being a left edge or a right edge of the information display object, a first boundary plane being a boundary plane specified by a line segment that connects the first edge and a third viewpoint when the parallax level has been set to the first parallax level, the third viewpoint being positioned between the first viewpoint and the second viewpoint, a first clipping plane being either clipping plane of a view volume that corresponds to the first viewpoint or a view volume that corresponds to the second viewpoint, and the first area being an area positioned between the first boundary plane and the first clipping plane.

15. An image generation method comprising:
acquiring positional relationship information about a screen of a display section and an observer;
selecting a first viewpoint and a second viewpoint that implement multi-view stereovision or spatial imaging stereovision based on the acquired positional relationship information;
generating a first-viewpoint image viewed from the first viewpoint and a second-viewpoint image viewed from the second viewpoint to generate a stereoscopic image; and
generating the stereoscopic image so that an information display object that presents information to the observer is stereoscopically displayed within a common area of a view volume that corresponds to the first viewpoint selected based on the positional relationship information and a view volume that corresponds to the second viewpoint selected based on the positional relationship information.

16. A computer-readable information storage medium storing a program that causes a computer to execute the image generation method as defined in claim 14.

17. A computer-readable information storage medium storing a program that causes a computer to execute the image generation method as defined in claim 15.
